(19) United States
(12) Patent Application Publication
(10) Pub. No.: US 2026/0279191 A1
(43) Pub. Date: Sep. 17, 2026

(54) FAULT PREDICTION METHOD AND APPARATUS, ELECTRONIC DEVICE, AND STORAGE MEDIUM

(71) Applicant: YANTAI JEREH OILFIELD SERVICES GROUP CO. LTD., Yantai (CN)

(72) Inventors: Hongxing WANG, Yantai (CN); Xinmeng WANG, Yantai (CN); Wenlong WANG, Yantai (CN); Yanqiang SUN, Yantai (CN); Hailong LI, Yantai (CN); Pu CAO, Yantai (CN); Bingqiang XU, Yantai, Shandong (CN); Lijian XIA, Yantai (CN); Meiyu SONG, Yantai (CN)

(73) Assignee: YANTAI JEREH OILFIELD SERVICES GROUP CO. LTD., Yantai (CN)

(21) Appl. No.: 19/672,092

(22) Filed: May 8, 2026

Related U.S. Application Data
(63) Continuation of application No. PCT/CN2025/071295, filed on Jan. 8, 2025.

(30) Foreign Application Priority Data
Nov. 9, 2023 (CN) 202311494002.6
Nov. 9, 2023 (CN) 202311495365.1
Nov. 24, 2023 (CN) 202311585660.6
Nov. 24, 2023 (CN) 202311587076.4

(51) Int. Cl. G08B 31/00; G01M 7/00; G01M 13/00

(52) U.S. Cl. CPC G08B 31/00; G01M 7/00; G01M 13/00

(57) ABSTRACT

A fault prediction method and apparatus, an electronic device, and a storage medium are disclosed. The method includes: obtaining vibration signals acquired by a sensor mounted on a target component of a target device, and cleaning and dividing the vibration signals to obtain a target vibration signal; inputting the target vibration signal to a target abnormality determining model, to obtain an output result, and determining, according to the output result, whether the target vibration signal is abnormal, to obtain an abnormality determination result; and inputting, in a case that the abnormality determination result represents that the target vibration signal is abnormal, the target vibration signal to a target fault prediction model, to obtain a fault prediction result, where the target fault prediction model is obtained by combining an encoder of the target abnormality determining model and a newly added fully-connected layer.

### CROSS-REFERENCE TO RELATED APPLICATIONS

This application is based on and claims the benefit of priority to PCT International Patent Application No. PCT/CN2025/071295, filed Jan. 8, 2025, and entitled “FAULT PREDICTION METHOD AND APPARATUS, ELECTRONIC DEVICE AND STORAGE MEDIUM,” where PCT International Patent Application No. PCT/CN2025/071295 is based on and claims the benefit of priority to Chinese Patent Application No. 202311494002.6, filed with the China National Intellectual Property Administration on Nov. 9, 2023, and entitled “FAULT MONITORING METHOD AND APPARATUS, STORAGE MEDIUM, AND ELECTRONIC DEVICE”, and where PCT International Patent Application No. PCT/CN2025/071295 is also based on and claims the benefit of priority to Chinese Patent Application No. 202311495365.1, filed with the China National Intellectual Property Administration on Nov. 9, 2023, and entitled “FAULT PREDICTION METHOD AND APPARATUS, STORAGE MEDIUM, AND ELECTRONIC DEVICE”, and where PCT International Patent Application No. PCT/CN2025/071295 is also based on and claims the benefit of priority to Chinese Patent Application No. 202311585660.6, filed with the China National Intellectual Property Administration on Nov. 24, 2023, and entitled “SENSOR FAULT IDENTIFICATION METHOD AND APPARATUS, ELECTRONIC DEVICE, AND STORAGE MEDIUM”, and where PCT International Patent Application No. PCT/CN2025/071295 is also based on and claims the benefit of priority to Chinese Patent Application No. 202311587076.4, filed with the China National Intellectual Property Administration on Nov. 24, 2023, and entitled “FAULT MONITORING METHOD AND APPARATUS FOR DYNAMIC EQUIPMENT, ELECTRONIC DEVICE, AND STORAGE MEDIUM”, each of which are hereby fully incorporated herein by reference in their entireties.

### TECHNICAL FIELD

The present disclosure relates to the field of device fault diagnosis, and more particularly, to a fault prediction method and apparatus, an electronic device, and a storage medium.

### BACKGROUND

A reciprocating device plays an important role in various industrial fields, and in particular, in the energy, chemical, and manufacturing industry. For example, a reciprocating compressor is widely applied to petroleum and natural gas extraction, chemical product manufacturing, and compression of air and other gases. To ensure continuity and production efficiency of a production process, the working efficiency and reliability of the reciprocating device are of great importance.

However, all components of the reciprocating device, such as a piston, a cylinder, a valve, a packing, and a valve body, are faulty due to long-time operation and wear. For example, if a piston ring of the reciprocating compressor is worn excessively, compression efficiency may be reduced, and even the compressor may be faulty.

Therefore, it is very necessary to monitor the health and integrity of the reciprocating device. Through regular maintenance and inspection, the fault of the device may be found and repaired in time, thereby avoiding damage to the device and interruption of the production process. This is very important to ensure effective operation of the energy industry and other industries.

Currently, when an operating condition of the reciprocating device is monitored, a device fault can usually be detected only when the fault occurs and obviously affects the operation of the device. However, in this case, the device has operated in the fault for a relatively long time. Therefore, the detection timeliness of this monitoring manner is relatively poor, the fault of the device cannot be found in time, and the device cannot be maintained.

Currently, no effective solution is provided to resolve a problem in the related art that only when a device has an obvious fault, the fault can be detected and the faulty device cannot be maintained in time.

### SUMMARY

The present disclosure provides a fault prediction method and apparatus, an electronic device, and a storage medium, to improve a fault monitoring speed and efficiency, and maintain a target device according to a fault cause in time.

According to a first aspect, the present disclosure provides a fault prediction method, including:
obtaining vibration signals acquired by a sensor mounted on a target component of a target device, and cleaning and dividing the vibration signals to obtain a target vibration signal;
inputting the target vibration signal to a target abnormality determining model, to obtain an output result, and determining, according to the output result, whether the target vibration signal is abnormal, to obtain an abnormality determination result, where the target abnormality determining model is obtained by training sample vibration signals of the target component, and the target abnormality determining model includes an encoder and a decoder; and
inputting, in a case that the abnormality determination result represents that the target vibration signal is abnormal, the target vibration signal to a target fault prediction model, to obtain a fault prediction result, where the target fault prediction model is obtained by combining the encoder of the target abnormality determining model and a newly added fully-connected layer, and the target fault prediction model is obtained by training using a plurality of fault types and a vibration signal of each fault type as samples.

With reference to the first aspect, in a first possible implementation of the first aspect, the cleaning and dividing the vibration signals to obtain the target vibration signal includes: dividing the vibration signal according to a time dimension, to obtain a plurality of first vibration signal segments, where each first vibration signal segment includes vibration signals under a same duration, and the duration includes a plurality of continuous vibration periods; sequentially determining whether an error signal exists in each of the first vibration signal segments, where the error signal represents abnormal operation of the sensor; deleting, in a case that an error signal exists in a first vibration signal segment, the first vibration signal with the error signal from the plurality of first vibration signal segments, to obtain a plurality of second vibration signals; and sequentially inputting each of the second vibration signals to a preset filter, to obtain a plurality of target vibration signals.

With reference to the first aspect, in a second possible implementation of the first aspect, the target abnormality determining model is obtained by training in the following manner: obtaining a sample vibration signal set of the target component, where the sample vibration signal set includes a plurality of sample vibration signals generated by the target component under normal operation; inputting the sample vibration signals in the sample vibration signal set to an initial abnormality determining model, to process the sample vibration signals and obtain an output signal corresponding to each of the sample vibration signals, where the initial abnormality determining model includes an encoder and a decoder, the encoder is configured to extract features of the sample vibration signals and reduce a data dimension, and the decoder is configured to recover the data dimension and recover a data feature; determining a difference value between each output signal and the corresponding sample vibration signal, to obtain a plurality of difference values, and determining whether a difference value that is greater than a preset threshold exists among the plurality of difference values; changing a neuron connection weight in the initial abnormality determining model in a case that the difference value that is greater than the preset threshold exists among the plurality of difference values, and retraining the changed initial abnormality determining model until no difference value that is greater than the preset threshold exists among the plurality of difference values; and obtaining the target abnormality determining model in a case that no difference value that is greater than the preset threshold exists among the plurality of difference values.

With reference to the first aspect, in a third possible implementation of the first aspect, the determining, according to the output result, whether the target vibration signal is abnormal, to obtain the abnormality determination result includes: determining a difference value between the output result and the target vibration signal, to obtain a target difference value, and determining whether the target difference value is greater than the preset threshold; determining, in a case that the target difference value is greater than the preset threshold, that the target vibration signal is abnormal; and determining, in a case that the target difference value is less than or equal to the preset threshold, that the target vibration signal is not abnormal.

With reference to the first aspect, in a fourth possible implementation of the first aspect, the target fault prediction model is obtained by training in the following manner: obtaining the plurality of fault types and a historical vibration signal under each of the fault types, to obtain a plurality of sets of historical vibration signals; adding a tag to each historical vibration signal in each set of historical vibration signals according to the fault type, to obtain a plurality of sets of updated historical vibration signals; and training an initial fault prediction model by using the plurality of sets of updated historical vibration signals as samples, to obtain the target fault prediction model.

With reference to the first aspect, in a fifth possible implementation of the first aspect, after obtaining the fault prediction result, the method further includes: obtaining a historical abnormal vibration signal acquired by the sensor when an anomaly occurs in the target component; determining feature information of the vibration signals of the target component according to the historical abnormal vibration signal, to obtain a plurality of pieces of feature information, and obtaining a feature value corresponding to each piece of feature information; determining a determination criterion of each piece of feature information according to the feature value corresponding to each piece of feature information, to obtain a plurality of determination criteria; obtaining, from the target vibration signal, a vibration data value corresponding to each piece of feature information, and performing abnormality determining on the vibration data value by using a determination criterion of the same feature information, to obtain a determination result; and determining, in a case that the determination result represents that the target vibration signal is not abnormal, that an anomaly exists in the target abnormality determining model, and transmitting alarm information, where the alarm information represents that an anomaly exists in the target abnormality determining model.

With reference to the first aspect, in a sixth possible implementation of the first aspect, the performing abnormality determining on the vibration data value by using the determination criterion of the same feature information, to obtain the determination result includes: obtaining the vibration data value under each piece of feature information and the determination criterion under the same feature information, and determining whether the vibration data value satisfies a corresponding determination criterion, to obtain a plurality of sub-determination results, where the sub-determination results are configured for representing whether the vibration data value satisfies the corresponding determination criterion; determining, in a case that a sub-determination result that does not satisfy the determination criterion exists among the plurality of sub-determination results, that the determination result indicates that the target vibration signal is abnormal; and determining, in a case that no sub-determination result that does not satisfy the determination criterion exists among the plurality of sub-determination results, that the determination result indicates that the target vibration signal is not abnormal.

According to a second aspect, the present disclosure further provides a fault prediction apparatus. The apparatus may include unit modules for performing the steps of the method in the implementations of the first aspect.

According to a third aspect, the present disclosure further provides a fault monitoring method, including:
obtaining an initial vibration signal acquired by a preset sensor, where the preset sensor is disposed at a target position on a target device, and the preset sensor is configured to acquire a vibration signal of the target position;
filtering the initial vibration signal using zero-phase filtering, to obtain an initial high-frequency signal;
obtaining a reference key phase signal of a reference device, determining a mapping relationship between time in the reference key phase signal and a rotation angle of the reference device according to a rotational speed of the reference device, and changing a horizontal coordinate of the initial high-frequency signal from a time value to a corresponding angle value according to the mapping relationship, to obtain a target angle-domain vibration signal, where the rotational speed of the reference device is the same as a rotational speed of the target device; and
obtaining standard data of the target device, detecting the target angle-domain vibration signal by using the standard data, to obtain a detection result, and determining a fault status of the target device according to the detection result, where the standard data is data in a vibration signal of the target device during normal operation.

With reference to the third aspect, in a first possible implementation of the third aspect, the filtering the initial vibration signal using zero-phase filtering, to obtain the initial high-frequency signal includes:
obtaining a preset high-pass filter, and inputting the initial vibration signal to the preset high-pass filter, to obtain a first time-domain signal;
flipping the first time-domain signal about a center line of an X axis, and inputting the flipped first time-domain signal to the preset high-pass filter, to obtain a second time-domain signal; and
flipping the second time-domain signal about the center line of the X axis, to obtain the initial high-frequency signal.

With reference to the third aspect, in a second possible implementation of the third aspect, after obtaining the reference key phase signal of the reference device, the method further includes:
determining a rotation period of the reference device according to the rotational speed of the reference device, and capturing a signal in a preset time period from the reference key phase signal, to obtain an updated reference key phase signal, where the preset time period includes a plurality of continuous rotation periods; and
capturing a signal in the preset time period from the initial high-frequency signal, to obtain an updated initial high-frequency signal; and
the determining the mapping relationship between the time in the reference key phase signal and the rotation angle of the reference device according to the rotational speed of the reference device, and changing the horizontal coordinate of the initial high-frequency signal from the time value to the corresponding angle value according to the mapping relationship, to obtain the target angle-domain vibration signal includes:
determining a mapping relationship between time in the updated reference key phase signal and the rotation angle of the reference device according to the rotational speed of the reference device, and converting the updated initial high-frequency signal according to the mapping relationship, to obtain the target angle-domain vibration signal.

With reference to the third aspect, in a third possible implementation of the third aspect, the reference device is provided with an encoder disc, the rotational speed of the reference device is the same as a rotational speed of the encoder disc, and the determining the mapping relationship between the time in the reference key phase signal and the rotation angle of the reference device according to the rotational speed of the reference device includes:
determining, according to the rotational speed, a number of revolutions of the encoder disc in the preset time period, to obtain a preset number of revolutions; and
determining a rotation angle corresponding to the preset number of revolutions, and determining, according to the rotation angle and the preset time period, a duration required for rotating by 1 degree, to obtain the mapping relationship.

With reference to the third aspect, in a fourth possible implementation of the third aspect, the changing the horizontal coordinate of the initial high-frequency signal from the time value to the corresponding angle value according to the mapping relationship, to obtain the target angle-domain vibration signal includes:
converting moment values in a time axis of the initial high-frequency signal to preset angle values according to the mapping relationship, to obtain an initial angle-domain vibration signal; and
determining whether each of the preset angle values has a corresponding amplitude value in the initial angle-domain vibration signal, obtaining, in a case that a target preset angle value does not have a corresponding amplitude value, a plurality of preset angle values neighboring to the target preset angle value and an amplitude value of each of the preset angle values, calculating an amplitude value of the target preset angle value according to the amplitude value of each of the preset angle values by using an interpolation method, and adding the amplitudes to corresponding positions in the initial angle-domain vibration signal, to obtain the target angle-domain vibration signal.

With reference to the third aspect, in a fifth possible implementation of the third aspect, the detecting the target angle-domain vibration signal by using the standard data, to obtain the detection result, and determining the fault status of the target device according to the detection result includes:
obtaining a verification angle and a standard amplitude at the verification angle from the standard data;
determining an amplitude at the verification angle in the target angle-domain vibration signal to obtain a target amplitude, and determining whether the target amplitude is greater than the standard amplitude;
determining, in a case that the target amplitude is greater than the standard amplitude, that the target device has a fault; and
determining, in a case that the target amplitude is less than or equal to the standard amplitude, that the target device does not have a fault.

With reference to the third aspect, in a sixth possible implementation of the third aspect, the determining the amplitude at the verification angle in the target angle-domain vibration signal to obtain the target amplitude includes:

obtaining an angle range in the target angle-domain vibration signal, and obtaining a number of rotation periods included in the angle range, to obtain a number of periods, where the angle range is greater than 360 degrees;
calculating an angle value corresponding to the verification angle in each period, to obtain a plurality of preset angles; and
determining a target angle corresponding to each preset angle in the target angle-domain vibration signal, to obtain a plurality of target angles, and obtaining an amplitude at each target angle, to obtain a plurality of target amplitudes.

According to a fourth aspect, the present disclosure further provides a fault monitoring apparatus. The apparatus may include unit modules for performing the steps of the method in the implementations of the third aspect.

According to a fifth aspect, the present disclosure further provides a fault monitoring method for dynamic equipment, applied to a fault monitoring system for dynamic equipment. The method includes:
determining a plurality of test points of a target dynamic equipment and a parameter retrieval rule of each of the test points;
retrieving, for each of the test points, target parameter data of the test point according to the corresponding parameter retrieval rule;
determining a fault symptom quantification of the test point according to the target parameter data;
determining an operating status of each of the test points based on the fault symptom quantification corresponding to each of the test points; and
determining a fault point and a fault type of the target dynamic equipment according to the operating status of each of the test points in a case of determining, according to the operating status of each of the test points, that the target dynamic equipment has a fault.

With reference to the fifth aspect, in a first possible implementation of the fifth aspect, the retrieving, for each of the test points, target parameter data of the test point according to the corresponding parameter retrieval rule includes:
obtaining, for each of the test points, the target parameter data corresponding to the test point from a preset database according to the parameter retrieval rule corresponding to the test point, where the database pre-stores the following types of parameter data of the target dynamic equipment: static attribute data of the target dynamic equipment, maintenance record data of the target dynamic equipment, operating data of the target dynamic equipment, and sensor signal data of the target dynamic equipment acquired by using a sensor; and
the method further includes:
obtaining a preset sensor acquisition rule; and
controlling, according to the sensor acquisition rule, a corresponding sensor to acquire corresponding sensor signal data.

With reference to the fifth aspect, in a second possible implementation of the fifth aspect, the determining the parameter retrieval rule of each of the test points includes:
obtaining position information of each of the test points on the target dynamic equipment; and
determining the parameter retrieval rule of each of the test points according to the position information; and
the determining the fault symptom quantification of the test point according to the target parameter data includes:
determining, according to the position information of the test point, a feature value calculation rule and a fault symptom quantification calculation rule corresponding to the test point;
performing calculation based on the target parameter data according to the feature value calculation rule, to obtain at least one feature value corresponding to the test point; and
performing data combination on the target parameter data and/or the feature value according to the fault symptom quantification calculation rule, to generate the fault symptom quantification of the test point.

With reference to the fifth aspect, in a third possible implementation of the fifth aspect, the determining the operating status of each of the test points based on the fault symptom quantification corresponding to each of the test points includes:
obtaining a maximum rotational speed and a minimum rotational speed of the target dynamic equipment within a plurality of operating periods;
determining a rotational speed difference between the maximum rotational speed and the minimum rotational speed, and determining whether the rotational speed difference is less than a preset difference threshold; and
determining, in a case that the rotational speed difference is less than the difference threshold, the operating status of each of the test points based on a preset dynamic early-warning model and the fault symptom quantification corresponding to each of the test points.

With reference to the fifth aspect, in a fourth possible implementation manner of the fifth aspect, the determining the operating status of each of the test points based on the preset dynamic early-warning model and the fault symptom quantification corresponding to each of the test points includes:
obtaining historical operating data of the target dynamic equipment within a preset historical time period and a configuration parameter of the preset dynamic early-warning model;
inputting the historical operating data, the fault symptom quantification corresponding to each of the test points, and the configuration parameter to the dynamic early-warning model, to obtain an early-warning result corresponding to each fault symptom quantification that is output by the dynamic early-warning model; and
determining the operating status of each of the test points based on the early-warning result corresponding to each fault symptom quantification, where the operating status includes a faulty state and a non-faulty state.

With reference to the fifth aspect, in a fifth possible implementation manner of the fifth aspect, the fault symptom quantification includes a sensor abnormality symptom quantity, and the determining the operating status of each of the test points based on the early-warning result corresponding to each fault symptom quantification includes:
determining whether an early-warning result corresponding to the sensor abnormality symptom quantity is fault early-warning;
outputting, if it is determined that the early-warning result corresponding to the sensor abnormality symptom quantity is fault early-warning, alarm information about an abnormality of the sensor, and ending the process;
obtaining, if the early-warning result corresponding to the sensor abnormality symptom quantity is non-fault early-warning, sensor signal data acquired by a sensor;
inputting the sensor signal data to a preset sensor fault identification model, to obtain a sensor abnormality identification result output by the sensor fault identification model;
determining, if the sensor abnormality identification result represents that an anomaly occurs in the sensor, that the operating status of each of the test points is the non-faulty state; and
determining, if the sensor abnormality identification result represents that no anomaly occurs in the sensor, an early-warning result level of each fault symptom quantification corresponding to each of the test points, and determining a fault status corresponding to an early-warning result having a highest early-warning result level as the operating status of the test point.

With reference to the fifth aspect, in a sixth possible implementation of the fifth aspect, the determining, according to the operating status of each of the test points, that the target dynamic equipment has a fault includes:
determining, in a case that the operating status of any of the test points is the faulty state, that the target dynamic equipment has a fault; and
the determining the fault point and the fault type of the target dynamic equipment according to the operating status of each of the test points includes:
determining whether the operating status of each of the test points is the faulty state;
determining a test point of which the operating status is the faulty state as an initial fault point; and
inputting, for each initial fault point, an early-warning result corresponding to the initial fault point to a preset fault detection model, to obtain the fault point and the fault type of the target dynamic equipment that are output by the fault detection model.

With reference to the fifth aspect, in a seventh possible implementation manner of the fifth aspect, the fault detection model includes a typical fault classification model and a fault analysis model, the typical fault classification model is configured to determine whether the fault type of the target dynamic equipment is a typical fault, the fault analysis model is configured to analyze a fault point and a basic fault type of the target dynamic equipment, and the inputting the early-warning result corresponding to the initial fault point to the preset fault detection model, to obtain the fault point and the fault type of the target dynamic equipment that are output by the fault detection model includes:
inputting the early-warning result corresponding to the initial fault point to the typical fault classification model and the fault analysis model respectively, to obtain a typical fault classification result output by the typical fault classification model and a fault analysis result output by the fault analysis model; and
performing weighted summation on the typical fault classification result and the fault analysis result, to obtain the fault point and the fault type corresponding to the target dynamic equipment.

With reference to the fifth aspect, in an eighth possible implementation manner of the fifth aspect, the method further includes:
determining whether the fault type is a typical fault type;
retrieval, in a case that the fault type is the typical fault type, the fault type against a preset typical fault case library, to obtain a target solution corresponding to the fault type, where the typical fault case library is configured for storing typical faults and a solution corresponding to each of the typical faults; and
outputting the target solution by using a visual interface.

With reference to the fifth aspect, in a ninth possible implementation manner of the fifth aspect, the method further includes:
performing, according to a preset signal processing rule, signal processing and feature transformation on the parameter data of the target dynamic equipment stored in the database, to obtain a plurality of types of graph data; and
outputting the graph data by using a visual interface, to analyze the target dynamic equipment according to the graph data.

With reference to the fifth aspect, in a tenth possible implementation of the fifth aspect, after determining the fault point and the fault type of the target dynamic equipment, the method further includes:
generating a three-dimensional image of the target dynamic equipment;
labeling the fault point and the fault type of the target dynamic equipment in the three-dimensional image, to obtain a target three-dimensional image; and
outputting the target three-dimensional image, and performing early-warning in a preset early-warning manner.

According to a sixth aspect, the present disclosure further provides a fault monitoring apparatus for dynamic equipment. The apparatus may include unit modules for performing the steps of the method in the implementations of the fifth aspect.

According to a seventh aspect, the present disclosure further provides a sensor fault identification method, including:
obtaining a historical sensor data set corresponding to a to-be-identified target sensor;
determining, according to the historical sensor data set, a fault identification model corresponding to the target sensor;
obtaining at least one preset mechanism model corresponding to the target sensor when actual sensor data of the target sensor is obtained, where the preset mechanism model is configured to identify whether the target sensor has a fault and identify a fault type corresponding to the target sensor when the target sensor has a fault; and
performing fault identification on the target sensor according to the fault identification model, the at least one preset mechanism model, and the actual sensor data, to obtain a target fault identification result corresponding to the target sensor.

With reference to the seventh aspect, in a first possible implementation of the seventh aspect, the fault identification model is configured to identify whether the target sensor is faulty due to environmental interference and identify an environmental fault type corresponding to the target sensor when the target sensor is faulty due to environmental interference; and

the performing fault identification on the target sensor according to the fault identification model, the at least one preset mechanism model, and the actual sensor data, to obtain the target fault identification result corresponding to the target sensor includes:

performing, for each preset mechanism model of the at least one preset mechanism model, fault identification on the target sensor according to the preset mechanism model and the actual sensor data, to obtain a first fault identification result corresponding to the target sensor; and

inputting the actual sensor data to the fault identification model when all the first fault identification results are that the target sensor does not have a fault, to enable the fault identification model to output the target fault identification result corresponding to the target sensor.

With reference to the seventh aspect, in a second possible implementation of the seventh aspect, the fault identification model is configured to identify whether the target sensor has a fault, identify a fault type corresponding to the target sensor when the target sensor has a fault, identify whether the target sensor is faulty due to environmental interference, and identify an environmental fault type corresponding to the target sensor when the target sensor is faulty due to environmental interference; and
the performing fault identification on the target sensor according to the fault identification model, the at least one preset mechanism model, and the actual sensor data, to obtain the target fault identification result corresponding to the target sensor includes:
performing, for each preset mechanism model of the at least one preset mechanism model, fault identification on the target sensor according to the preset mechanism model and the actual sensor data, to obtain a first fault identification result corresponding to the target sensor;
inputting the actual sensor data to the fault identification model, to enable the fault identification model to output a second fault identification result corresponding to the target sensor; and
determining the target fault identification result corresponding to the target sensor according to all the first fault identification results and the second fault identification result.

With reference to the seventh aspect, in a third possible implementation of the seventh aspect, the determining the target fault identification result corresponding to the target sensor according to all the first fault identification results and the second fault identification result includes:
determining whether fault identification results consistent with all the first fault identification results exist in the second fault identification result;
determining, when fault identification results consistent with all the first fault identification results exist in the second fault identification result, the second fault identification result as the target fault identification result corresponding to the target sensor;
generating, when a fault identification result inconsistent with at least one of the first fault identification results exists in the second fault identification result, alarm prompt information according to the at least one inconsistent first fault identification result; and
pushing the alarm prompt information to a target terminal corresponding to the target sensor.

With reference to the seventh aspect, in a fourth possible implementation of the seventh aspect, the determining, according to the historical sensor data set, the fault identification model corresponding to the target sensor includes:
performing, for each piece of historical sensor data in the historical sensor data set, fault classification labeling on the historical sensor data, to obtain training sample data corresponding to the historical sensor data; and
training a preset classification model according to the training sample data corresponding to all the historical sensor data in the historical sensor data set, to obtain the fault identification model corresponding to the target sensor.

With reference to the seventh aspect, in a fifth possible implementation manner of the seventh aspect, the at least one preset mechanism model includes a bias voltage model, an output signal model, and a spectrum model, the actual sensor data includes an actual bias voltage, an actual output signal value, and an actual spectrum, each preset mechanism model stores a preset threshold and a correspondence between a comparison result and a fault identification result, and the comparison result is a result of comparison between the actual sensor data and the preset threshold; and
the performing fault identification on the target sensor according to the preset mechanism model and the actual sensor data, to obtain the first fault identification result corresponding to the target sensor includes:
comparing, when the preset mechanism model is the bias voltage model, the actual bias voltage with the preset threshold in the bias voltage model, to obtain a first comparison result; and determining a first fault identification result corresponding to the first comparison result according to the correspondence between the comparison result and a fault identification result in the bias voltage model;
comparing, when the preset mechanism model is the output signal model, the actual output signal value with the preset threshold in the output signal model, to obtain a second comparison result; and determining a first fault identification result corresponding to the second comparison result according to the correspondence between the comparison result and a fault identification result in the output signal model; and
determining, when the preset mechanism model is the spectrum model, a ski slope factor according to the actual spectrum; comparing the ski slope factor with the preset threshold in the spectrum model, to obtain a third comparison result; and determining a first fault identification result corresponding to the third comparison result according to the correspondence between the comparison result and a fault identification result in the spectrum model.

With reference to the seventh aspect, in a sixth possible implementation of the seventh aspect, the determining the ski slope factor according to the actual spectrum includes:
obtaining a plurality of preset frequency intervals corresponding to the target sensor;
determining, for each of the preset frequency intervals, a pass frequency within the preset frequency interval according to the actual spectrum; and
determining the ski slope factor according to all the pass frequencies.

According to an eighth aspect, the present disclosure further provides a sensor fault identification apparatus. The apparatus may include unit modules for performing the steps of the method in the implementations of the seventh aspect.

According to a ninth aspect, the present disclosure provides an electronic device, including: a processor and a memory. The processor is connected to the memory. The processor is configured to execute a fault prediction program, a fault monitoring program, dynamic equipment fault monitoring program, or a sensor fault identification program stored in the memory, to implement the fault prediction method according to the first aspect, the fault monitoring method according to the third aspect, the fault monitoring method for dynamic equipment according to the fifth aspect, or the sensor fault identification method according to the seventh aspect.

According to a tenth aspect, the present disclosure further provides a storage medium. The storage medium stores one or more programs. The one or more programs may be executed by one or more processors, to implement the fault prediction method according to the first aspect, the fault monitoring method according to the third aspect, the fault monitoring method for dynamic equipment according to the fifth aspect, or the sensor fault identification method according to the seventh aspect.

By using the fault prediction method and apparatus, the electronic device, and the storage medium provided in the embodiments of the present disclosure, a problem in the related art that only when a device has an obvious fault, the fault can be detected and the faulty device cannot be maintained in time is resolved. After a vibration signal of a target component is preprocessed, a target abnormality determining model determines whether the acquired vibration signal is abnormal. In a case that an abnormality exists, a target fault prediction model determines a cause of the abnormality in the vibration signal, so that the two models may quickly determine whether the target component has a fault and determines a cause of the fault, thereby improving a fault monitoring speed and efficiency, and maintaining the target device according to the cause of the fault in time.

### BRIEF DESCRIPTION OF THE DRAWINGS

To more clearly explain the technical solutions in the embodiments of the present disclosure, the accompanying drawings that need to be used in the embodiments will be briefly introduced below. It is apparent that for those of ordinary skill in the art, other accompanying drawings may be obtained from these accompanying drawings without making creative labor.

FIG. 1 is a flowchart of a fault prediction method according to an embodiment of the present disclosure;

FIG. 2 is a schematic diagram of a model structure of an example abnormality determining model according to an embodiment of the present disclosure;

FIG. 3 is a training flowchart of an abnormality determining model according to an embodiment of the present disclosure;

FIG. 4 is a training flowchart of a fault prediction model according to an embodiment of the present disclosure;

FIG. 5 is a schematic diagram of a fault prediction apparatus according to an embodiment of the present disclosure;

FIG. 6 is a flowchart of a fault monitoring method according to an embodiment of the present disclosure;

FIG. 7 is a schematic diagram of an example reference key phase signal according to an embodiment of the present disclosure;

FIG. 8 is a schematic diagram of an example initial high-frequency signal according to an embodiment of the present disclosure;

FIG. 9 is a schematic diagram of an example target angle-domain vibration signal according to an embodiment of the present disclosure;

FIG. 10 is a flowchart of a zero-phase filtering manner according to an embodiment of the present disclosure;

FIG. 11 is a schematic diagram of a fault monitoring apparatus according to an embodiment of the present disclosure;

FIG. 12 is a schematic structural diagram of a fault monitoring system for dynamic equipment according to an embodiment of the present disclosure;

FIG. 13 is a flowchart of an embodiment of a fault monitoring method for dynamic equipment according to an embodiment of the present disclosure;

FIG. 14 is a flowchart of an embodiment of another fault monitoring method for dynamic equipment according to an embodiment of the present disclosure;

FIG. 15 is a flowchart of an embodiment of still another fault monitoring method for dynamic equipment according to an embodiment of the present disclosure;

FIG. 16 is a schematic diagram of a threshold configuration data function interface according to an embodiment of the present disclosure;

FIG. 17 is a schematic diagram of a historical alarm log data function interface according to an embodiment of the present disclosure;

FIG. 18 is a flowchart of an embodiment of yet another fault monitoring method for dynamic equipment according to an embodiment of the present disclosure;

FIG. 19 is a schematic structural diagram of another fault monitoring system for dynamic equipment according to an embodiment of the present disclosure;

FIG. 20 is a block diagram of an embodiment of a fault monitoring apparatus for dynamic equipment according to an embodiment of the present disclosure;

FIG. 21 is a schematic flowchart of a sensor fault identification method according to an embodiment of the present disclosure;

FIG. 22 is a schematic flowchart of another sensor fault identification method according to an embodiment of the present disclosure;

FIG. 23 is a schematic flowchart of still another sensor fault identification method according to an embodiment of the present disclosure;

FIG. 24 is a schematic diagram of a sensor disconnection bias voltage according to an embodiment of the present disclosure;

FIG. 25 is a schematic diagram of a sensor short-circuit bias voltage according to an embodiment of the present disclosure;

FIG. 26 is a schematic diagram of a ski slope according to an embodiment of the present disclosure;

FIG. 27 is a schematic structural diagram of a sensor fault identification apparatus according to an embodiment of the present disclosure; and

FIG. 28 is a schematic structural diagram of an electronic device according to an embodiment of the present disclosure.

### DETAILED DESCRIPTION

In embodiments of the present disclosure,
to make the objects, technical solutions, and advantages of embodiments of the present disclosure clearer, the following clearly and completely describes the technical solutions in the embodiments of the present disclosure with reference to the accompanying drawings in the embodiments of the present disclosure. It is apparent that the described embodiments are a part of the embodiments of the present disclosure rather than all of the embodiments. Based on the embodiments in the present disclosure, all other embodiments obtained by those of ordinary skill in the art without making creative labor fall within the scope of protection of the present disclosure.

The following disclosure provides a number of different embodiments or examples for implementing different structures of the present disclosure. To simplify the disclosure of the present disclosure, components and settings in particular examples are described below. Certainly, they are merely examples and are not intended to limit the present disclosure. In addition, in the present disclosure, reference numerals and/or letters may be repeated in different examples. This repetition is for the purpose of simplicity and clarity, and does not indicate relationships between the embodiments and/or settings discussed.

It should be noted that a fault prediction method determined in the present disclosure may be applied to the field of device fault diagnosis, or may be applied to any field other than the field of device fault diagnosis. Application fields of the fault prediction method and apparatus, the storage medium, and the electronic device determined in the present disclosure are not limited.

For ease of description, some nouns or terms related to the embodiments of the present disclosure are described below.

A CNN autoencoder is a model combining a convolutional neural network (CNN) and an autoencoder, and may be configured for tasks such as image noise reduction, image denoising, and feature extraction.

According to an embodiment of the present disclosure, a fault prediction method is provided.

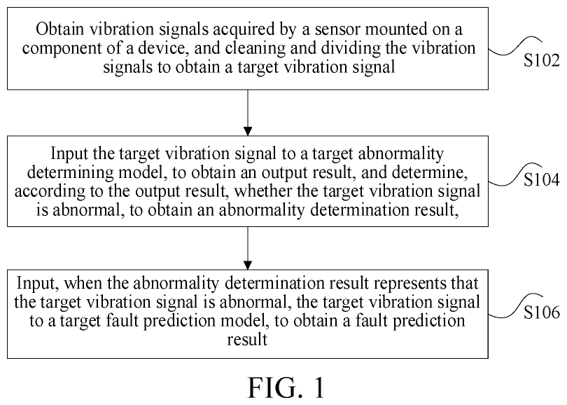

FIG. 1 is a flowchart of a fault prediction method according to an embodiment of the present disclosure. As shown in FIG. 1, the method includes the following steps.
Step S102: Obtain vibration signals acquired by a sensor mounted on a target component of a target device, and clean and divide the vibration signals to obtain a target vibration signal.

Specifically, the target device may be a reciprocating device. When the target device has a fault, a faulty member is relatively fixed, for example, a piston or a cylinder, and a vibration signal of a part of members during operation may feed back whether the operation of the device is abnormal. Therefore, a sensor may be mounted on a target component that is often faulty in the target device, so as to determine whether the target component is faulty according to a vibration signal, which is acquired by the sensor, of the target component during operation of the target device.

Further, after the vibration signal acquired by the sensor on the target component is received, because the sensor may be abnormal, or an operating condition of the target device is unstable, or signal interference causes noise or an abnormal signal in the vibration signal, the vibration signal needs to be cleaned, so that signal availability and accuracy are relatively high. In addition, because the vibration signal is continuously acquired as the device operates, the acquired vibration signal may be divided during analysis of the vibration signal, and a vibration signal for analysis is selected, thereby improving fault identification accuracy.

It should be noted that the signal detected by the sensor is a time-domain signal. A sensor device is mounted at a target position of the sensor close to the monitored target component in a manner including contact mounting (for example, for a vibration sensor) and non-contact mounting (for example, for an ultrasonic sensor). Original measurement data of a corresponding channel is acquired by using a unidirectional or multi-directional sensor, a related channel acquisition parameter is configured by using data acquisition software, and time-domain measurement data is acquired according to a specified acquisition frequency. Meanwhile, by using some signal processing methods (for example, wavelet transform, empirical modality decomposition, and filtering), an irrelevant interference signal is removed, and related information of monitored parts appears, so as to perform a subsequent prediction operation according to the processed vibration signal.

For example, a fault of a valve assembly at a fluid end of a five-cylinder plunger pump of a fracturing device is predicted. A vibration sensor is mounted at an appropriate position of the fluid end to acquire time-domain vibration measurement data capable of reflecting an operating mechanism of the valve assembly. A corresponding position sensor and acquired original vibration data are labeled as AI1-5, and a sampling frequency of the sensor is 25600 Hz.
Step S104: Input the target vibration signal to a target abnormality determining model, to obtain an output result, and determine, according to the output result, whether the target vibration signal is abnormal, to obtain an abnormality determination result, where the target abnormality determining model is obtained by training sample vibration signals of the target component, and the target abnormality determining model includes an encoder and a decoder.

Specifically, after the target vibration signal is obtained by processing the vibration signal, the target vibration signal needs to be input to a target abnormality determining model, to obtain an output result. The target abnormality determining model may be a CNN autoencoder. Feature information of the input vibration signal may be identified by using an encoder in the target abnormality determining model, and the vibration signal is reconstructed by using a decoder, so as to determine, according to a difference value (which may alternatively be referred to as a loss value) between the reconstructed vibration signal and the target vibration signal, whether the target vibration signal is abnormal.

It should be noted that when the target abnormality determining model is trained, only the vibration signal of the target component in a normal operating state of the target device is used for training. Therefore, when a vibration signal acquired in an abnormal state is input to the target abnormality determining model, the target abnormality determining model cannot perform an accurate reconstruction operation on the vibration signal, resulting in a large difference value between a generated reconstructed vibration signal and the vibration signal acquired in the abnormal state. Therefore, whether the target vibration signal is abnormal may be determined according to the difference value.
Step S106: Input, in a case that the abnormality determination result represents that the target vibration signal is abnormal, the target vibration signal to a target fault prediction model, to obtain a fault prediction result, where the target fault prediction model is obtained by combining the encoder of the target abnormality determining model and a newly added fully-connected layer, and the target fault prediction model is obtained by training using a plurality of fault types and a vibration signal of each fault type as samples.

Specifically, in a case that the target vibration signal is abnormal, the cause of an abnormality of the target device cannot be known due to a variety of abnormalities. Therefore, the target vibration signal needs to be input to the target fault prediction model, and the cause of a fault of the target device is determined by using the target fault prediction model, to accurately determine the cause of the fault based on that the target device has a fault, thereby assisting operation and maintenance personnel in device maintenance.

It should be noted that the target abnormality determining model has been trained, and the target fault prediction model also needs to train a feature extraction portion. In addition, because a quantity of fault signals is limited, it is difficult to train an effective fault classification model according to only the fault signal. Therefore, a fault classification and identification model based on transfer learning may be constructed based on a conventional target abnormality determining model, and an encoder portion of the target abnormality determining model is used as the feature extraction portion of the target fault prediction model, thereby reducing dependency on new data and shortening training time.

In the fault prediction method provided in this embodiment of the present disclosure, vibration signals acquired by a sensor mounted on a target component of a target device is obtained, and the vibration signal is cleaned and divided to obtain a target vibration signal. The target vibration signal is input to a target abnormality determining model, to obtain an output result. According to the output result, whether the target vibration signal is abnormal is determined, to obtain an abnormality determination result, where the target abnormality determining model is obtained by training sample vibration signals of the target component, and the target abnormality determining model includes an encoder and a decoder. In a case that the abnormality determination result represents that the target vibration signal is abnormal, the target vibration signal is input to a target fault prediction model, to obtain a fault prediction result, where the target fault prediction model is obtained by combining the encoder of the target abnormality determining model and a newly added fully-connected layer, and the target fault prediction model is obtained by training using a plurality of fault types and a vibration signal of each fault type as samples. A problem in the related art that only when a device has an obvious fault, the fault can be detected and the faulty device cannot be maintained in time is resolved. After a vibration signal of a target component is preprocessed, a target abnormality determining model determines whether the acquired vibration signal is abnormal. In a case that an abnormality exists, a target fault prediction model determines a cause of the abnormality in the vibration signal, so that the two models may quickly determine whether the target component has a fault and determines a cause of the fault, thereby improving a fault monitoring speed and efficiency, and maintaining the target device according to the cause of the fault in time.

To ensure high signal availability, in some example implementations, in the fault prediction method provided in this embodiment of the present disclosure, the cleaning and dividing the vibration signals to obtain a target vibration signal includes: dividing the vibration signals according to a time dimension, to obtain a plurality of first vibration signal segments, where each first vibration signal segment includes vibration signals under a same duration, and the duration includes a plurality of continuous vibration periods; sequentially determining whether an error signal exists in each of the first vibration signal segments, where the error signal represents abnormal operation of the sensor; deleting, in a case that an error signal exists in a first vibration signal segment, the first vibration signal with the error signal from the plurality of first vibration signal segments, to obtain a plurality of second vibration signals; and sequentially inputting each of the second vibration signals to a preset filter, to obtain a plurality of target vibration signals.

Specifically, after a vibration signal is obtained, the vibration signal is divided according to time granularity (each signal segment obtained after the division according to the time granularity includes at least working information of the target component in one entire period, and therefore, at least time in which the target component works for two periods needs to be captured as the time granularity), so as to obtain a set of a plurality of vibration signals obtained after the division, where the set includes a plurality of vibration signals.

Further, whether an error signal exists in each vibration signal needs to be determined. The error signal may be that an anomaly occurs in the sensor, an operating condition of the target device is unstable, or signal interference is generated, thereby causing noise or an abnormal signal in the vibration signal. The error signal is removed in the presence of the error signal.

Further, after the error signal is removed, a frequency interval that needs to be focused on and an interference frequency element that needs to be filtered out need to be deduced according to a mechanic feature of the monitored target component. For each vibration signal in the vibration signal set after the error signal is removed, an interference element (including interference such as noise and information transferred by another component) is removed by using a signal processing algorithm, to obtain a processed signal, so that feature information of the target component appears, thereby laying a foundation for a subsequent feature extraction operation, and improving accuracy of feature extraction.

In some example implementations, in the fault prediction method provided in this embodiment of the present disclosure, the target abnormality determining model is obtained by training in the following manner: obtaining a sample vibration signal set of the target component, where the sample vibration signal set includes a plurality of sample vibration signals generated by the target component under normal operation; inputting the sample vibration signals in the sample vibration signal set to an initial abnormality determining model, to process the sample vibration signals and obtain an output signal corresponding to each of the sample vibration signals, where the initial abnormality determining model includes an encoder and a decoder, the encoder is configured to extract features of the sample vibration signals and reduce a data dimension, and the decoder is configured to recover the data dimension and recover a data feature; determining a difference value between each output signal and the corresponding sample vibration signal, to obtain a plurality of difference values, and determining whether a difference value that is greater than a preset threshold exists among the plurality of difference values; changing a neuron connection weight in the initial abnormality determining model in a case that the difference value that is greater than the preset threshold exists among the plurality of difference values, and retraining the changed initial abnormality determining model until no difference value that is greater than the preset threshold exists among the plurality of difference values; and obtaining the target abnormality determining model in a case that no difference value that is greater than the preset threshold exists among the plurality of difference values.

It should be noted that when an abnormality determining model is trained, after sample vibration signals used for training are obtained, data also needs to be labeled, cleaned, and divided, and the signals are filtered to obtain a plurality of sample vibration signals, thereby ensuring a model training effect and accuracy.

Further, the target abnormality determining model needs to determine, according to a difference value between an output result and an input signal, whether the target vibration signal is abnormal. Therefore, sample vibration signals used when the model is trained need to be vibration signals generated when the target component operates normally, and a normal vibration signal is learned by using the abnormality determining model, so that a difference value between a result obtained after processing the normal vibration signal and the input signal is less than a preset threshold. In this case, after the abnormal vibration signal is input to the target abnormality determining model, the model is not trained by using the abnormal vibration signal during training. Therefore, after the result is output according to the abnormal vibration signal, a difference value between an output signal and an input abnormal vibration signal is much greater than the preset threshold. In this case, whether the input vibration signal is an abnormal vibration signal may be determined according to a quantity relationship between the difference value and the preset threshold.

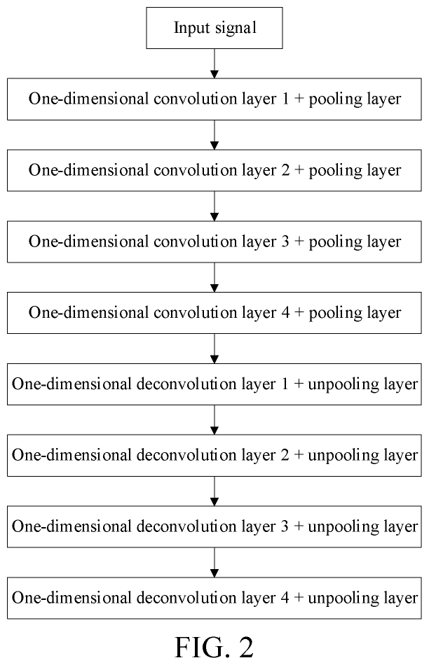

It should be noted that the initial abnormality determining model includes an encoder and a decoder. The encoder is configured to extract features of sample vibration signals and reduce a data dimension. The decoder is configured to recover the data dimension and recover a data feature. FIG. 2 is a schematic diagram of a model structure of an example abnormality determining model according to an embodiment of the present disclosure. As shown in FIG. 2, the encoder portion includes four one-dimensional convolution layers and four pooling layers. The one-dimensional convolution layers are used for extracting a local feature of input data, and the pooling layers are used for reducing the data dimension and reduce a calculation amount. The decoder portion includes four one-dimensional deconvolution layers and four unpooling layers. The one-dimensional deconvolution layers are used for recovering data obtained after dimension reduction of the encoder portion to an original dimension, and the unpooling layers are used for recovering a local feature of the data. Neurons of the model use a ReLu activation function. A loss function, namely an MSE function, is used to input data and predict reconstructed data to calculate a final network loss. An Adam function is used to optimize a neuron connection weight in a model training process. In a case that the difference value between the output result and the input signal is greater than the preset threshold during model training, the neuron connection weight is adjusted, to optimize the model, thereby completing model training.

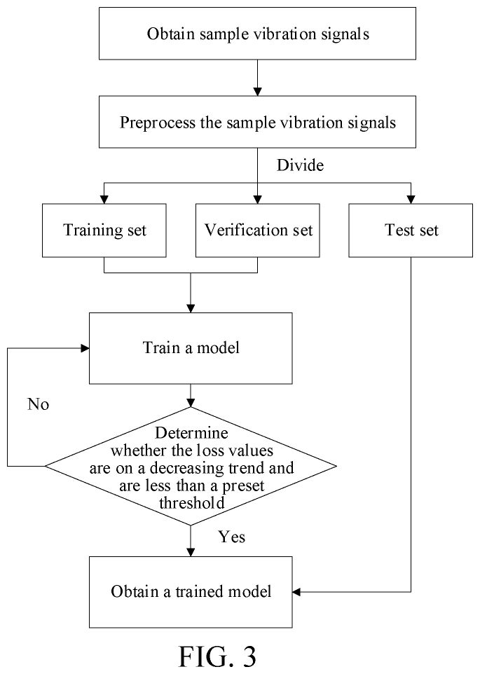

FIG. 3 is a training flowchart of an abnormality determining model according to an embodiment of the present disclosure. As shown in FIG. 3, sample vibration signals of a target component under normal operation are first obtained, the sample vibration signals are labeled (labeled as normal operating values), cleaned, and divided, and an interference element is removed, to obtain processed sample vibration signals. The sample vibration signals are classified into a training set, a verification set, and a test set.

A CNN autoencoder model is trained by using the training set and the verification set. The sample vibration signals are processed according to the trained model, to obtain a plurality of loss values, and whether the loss values are on a decreasing trend and are all less than a preset threshold is determined. In a case that the loss values are not less than the preset threshold, training is performed again after a parameter or a weight in the model is changed, so that the loss values are on a decreasing trend and are all less than the preset threshold. In this case, model training is completed, the model is tested by using the test set, and after the tested model has no fault, a trained target abnormality determining model is obtained.

A training case for an abnormality determining model is as follows:

Experimental data is data at a fluid end of a five-cylinder plunger pump of a fracturing device and AI1-5 sensor data at an appropriate position and in an appropriate direction. A plurality of key components of each cylinder are acquired respectively, and a sampling frequency is 25600 Hz. AI1-5 sensor data of a total eight devices normally operating in the past 9 days is obtained. Vibration data acquired by each sensor is cleaned and divided, and an interference element is removed. Because mechanisms of a plurality of components in each cylinder are similar, signals acquired by the five sensors are combined to train a fault prediction model. 27681 pieces of normal data are generated, and sample division is performed according to a ratio of 7:2:1, to obtain a total of 19376 pieces of normal training data, 5537 pieces of normal test data, and 2768 pieces of normal verification data.

Based on the foregoing training data and test data, model training and model testing are performed, and related parameters are as follows:

After the training is completed, a fault alarm threshold is defined by using all network losses of a training set: threshold=4 Q₃-301, where Q₃ is an upper quartile in all loss values of the training set and Q₁ is a lower quartile in all the loss values of the training set. Finally, 99% of all loss values of the training set, a test set, and a verification set are less than threshold. In addition, verification is performed by using fault data of a plurality of devices. It is found that the network loss tends to change before a fault occurs, and can be used as a fault feature factor to predict in advance that the fault occurs at the fluid end.

In some example implementations, the determining, according to the output result, whether the target vibration signal is abnormal, to obtain an abnormality determination result includes: determining a difference value between the output result and the target vibration signal, to obtain a target difference value, and determining whether the target difference value is greater than the preset threshold; determining, in a case that the target difference value is greater than the preset threshold, that the target vibration signal is abnormal; and determining, in a case that the target difference value is less than or equal to the preset threshold, that the target vibration signal is not abnormal.

Specifically, after training of the target abnormality determining model is completed, in a case of determining whether the target vibration signal is an abnormal signal by using the target abnormality determining model, a plurality of signals having a same length are used during training of the target abnormality determining model. Therefore, each target vibration signal needs to be input to the target abnormality determining model, an output result of each target vibration signal is generated by using the target abnormality determining model, and a difference value between each output result and a corresponding input vibration signal is determined. In a case that one or more difference values are greater than a preset threshold, it represents that the vibration signal is abnormal, and a subsequent abnormality determining step needs to be performed. In a case that the difference value between the vibration signals is less than the preset threshold, it represents that the target vibration signal is not abnormal.

In some example implementations, in the fault prediction method provided in this embodiment of the present disclosure, the target fault prediction model is obtained by training in the following manner: obtaining the plurality of fault types and a historical vibration signal under each of the fault types, to obtain a plurality of sets of historical vibration signals; adding a tag to each historical vibration signal in each set of historical vibration signals according to the fault type, to obtain a plurality of sets of updated historical vibration signals; and training an initial fault prediction model by using the plurality of sets of updated historical vibration signals as samples, to obtain the target fault prediction model.

Specifically, when the target fault prediction model is trained, a fault reason needs to be determined by using the model in this case. Therefore, when sample data is obtained, the sample data needs to include a historical vibration signal under each of the fault types. These historical vibration signals are all vibration signals generated by the target component when a fault occurs. Similarly, a vibration signal of the target component when the target component normally operates is also needed in the sample data for training the model.

During model training, a tag needs to be added to each historical vibration signal, where the tag is configured for determining a fault type corresponding to each vibration signal, and the initial fault prediction model is trained by using the vibration signal with the tag, to obtain the target fault prediction model.

It should be noted that the number of faults is relatively small, and some types of faults may only occur once. Therefore, a quantity of vibration signals under a fault is relatively small, resulting in a relatively small number of samples during model training, and the model cannot be accurately trained. In this case, a feature identification portion of the trained abnormality determining model may be used as a feature identification portion of the fault prediction model, and the fault prediction model is trained based on the feature identification portion, thereby improving identification accuracy of the feature identification portion, and improving accuracy of the fault prediction model.

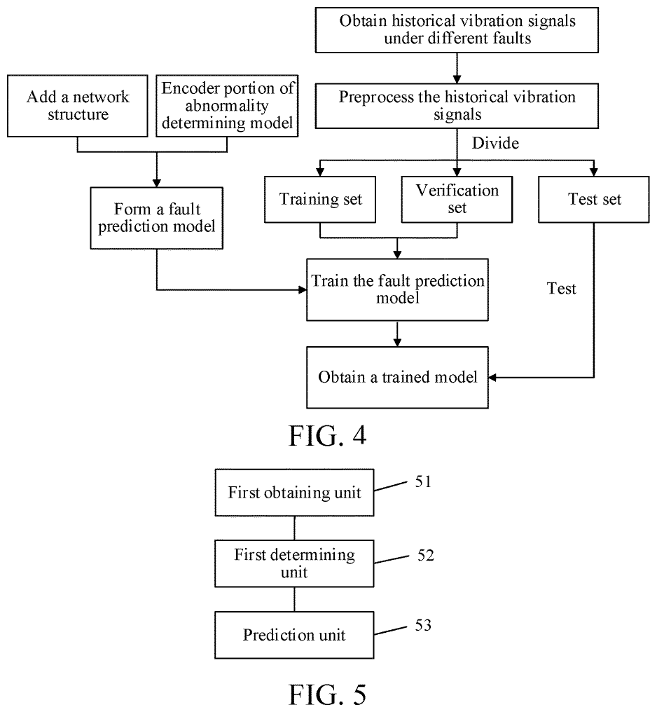

FIG. 4 is a training flowchart of a fault prediction model according to an embodiment of the present disclosure. As shown in FIG. 4, historical vibration signals of a target component under normal operation and abnormal operation are first obtained, the historical vibration signals are labeled, cleaned, and divided, and an interference element is removed, to obtain processed historical vibration signals. The historical vibration signals are classified into a training set, a verification set, and a test set.

An encoder portion of the target abnormality determining model is obtained as a feature extraction portion of the fault prediction model. Based on this, two one-dimensional convolution layers and two pooling layers are added to continue dimension reduction, and a fully-connected layer is finally added to a network, to obtain the fault prediction model. The fault prediction model is trained by using the training set and the verification set, and after being trained, the fault prediction model is tested by using the test set, thereby completing training of the fault prediction model.

A training case for a fault prediction model is as follows:

For example, an encoder portion in a trained abnormality determining model has learned useful features of input data. Therefore, a network structure and parameter of the encoder portion in the abnormality determining model are reserved. Based on this, two one-dimensional convolution layers and two pooling layers are added to continue dimension reduction, and a fully-connected layer is finally added to a network, to implement fault classification.

Neurons of the model use a ReLu activation function. A loss function, namely a categorical_crossentropy function, is used to input a data tag and predict the data tag to calculate a final classification accuracy. An Adam function is also used to optimize a neuron connection weight in a model training process.

It should be noted that when a new network is trained, a migrated encoding layer has a preliminarily trained network parameter, and a new network structure is an initialized network parameter. In addition, because fault data of different components is added, a feature extraction capability of an encoder portion of the original network structure for the fault data is still insufficient. Therefore, when a new network is trained, distribution training needs to be performed. First, all migration network layers are frozen, and parameters in all new network layers are trained, to adapt to a new classification task. Then, parameters of the layers in the migration network are unfrozen layer by layer, and parameters of the migration network are fine-tuned to enhance a feature extraction capability of the migration network for the fault data. When the identification accuracy of the verification set does not obviously increase, the training is ended.

To determine whether a result obtained by the target abnormality determining model is accurate, in some example implementations, in the fault prediction method provided in this embodiment of the present disclosure, after the obtaining the fault prediction result, the method further includes: obtaining a historical abnormal vibration signal acquired by the sensor when an anomaly occurs in the target component; determining feature information of the vibration signals of the target component according to the historical abnormal vibration signal, to obtain a plurality of pieces of feature information, and obtaining a feature value corresponding to each piece of feature information; determining a determination criterion of each piece of feature information according to the feature value corresponding to each piece of feature information, to obtain a plurality of determination criteria; obtaining, from the target vibration signal, a vibration data value corresponding to each piece of feature information, and performing abnormality determining on the vibration data value by using a determination criterion of the same feature information, to obtain a determination result; and determining, in a case that the determination result represents that the target vibration signal is not abnormal, that an anomaly exists in the target abnormality determining model, and transmitting alarm information, where the alarm information represents that an anomaly exists in the target abnormality determining model.

Specifically, after the fault prediction result is obtained, there may be a problem that the model prediction is inaccurate. To be specific, the target component does not operate abnormally, but a result output by the model determines that the target component has a fault. In this case, feature information in the historical vibration signal needs to be first determined. The feature information may include: a time-domain feature (such as a kurtosis, a peak value, or an effective value), a frequency-domain feature (such as a center of gravity frequency or a mean square frequency), and other related features (such as permutation entropy and dispersion entropy). A feature value and a determination criterion of each piece of feature information are determined. For example, the feature value of the peak value in the feature information may be 100, the determination criterion is that the peak value less than 100 is normal and the peak value greater than 100 is abnormal, and whether the target vibration signal is abnormal may be determined according to the foregoing determination criterion.

Further, after the target vibration signal is determined according to each of the foregoing determination criteria, whether the target vibration signal is abnormal may be determined according to a determination result. When it is determined, according to the determination result, that the target vibration model is not abnormal, it represents that an anomaly exists in the target abnormality determining model, and the abnormal target abnormality determining model needs to be adjusted, so as to achieve an effect of monitoring the model.

To determine whether the target vibration signal is abnormal, in some example implementations, in the fault prediction method provided in this embodiment of the present disclosure, the performing abnormality determining on the vibration data value by using the determination criterion of the same feature information, to obtain the determination result includes: obtaining the vibration data value under each piece of feature information and the determination criterion under the same feature information, and determining whether the vibration data value satisfies a corresponding determination criterion, to obtain a plurality of sub-determination results, where the sub-determination results are configured for representing whether the vibration data value satisfies the corresponding determination criterion; determining, in a case that a sub-determination result that does not satisfy the determination criterion exists among the plurality of sub-determination results, that the determination result indicates that the target vibration signal is abnormal; and determining, in a case that no sub-determination result that does not satisfy the determination criterion exists among the plurality of sub-determination results, that the determination result indicates that the target vibration signal is not abnormal.

Specifically, when the determination result is generated, a sub-determination result of each determination criterion needs to be obtained. When all the sub-determination results represent that the vibration data value satisfies the corresponding determination criterion, it is determined that the target vibration signal is not abnormal. When any sub-determination result represents that the vibration data value does not satisfy the corresponding determination criterion, it is determined that the target vibration signal is abnormal, thereby accurately determining whether the target vibration signal is abnormal.

It should be noted that the steps shown in the flowchart of the accompanying drawings may be performed, for example, in a computer system storing a set of computer-executable instructions. In addition, although a logic order is shown in the flowchart, in some cases, the shown or described steps may be performed in an order different from the order herein.

An embodiment of the present disclosure further provides a fault prediction apparatus. It should be noted that the fault prediction apparatus according to this embodiment of the present disclosure may be configured to perform the fault prediction method according to the foregoing embodiment of the present disclosure. The following describes the fault prediction apparatus provided in this embodiment of the present disclosure.

FIG. 5 is a schematic diagram of a fault prediction apparatus according to an embodiment of the present disclosure. As shown in FIG. 5, the apparatus includes: a first obtaining unit 51, a first determining unit 52, and a prediction unit 53.

The first obtaining unit 51 is configured to obtain vibration signals acquired by a sensor mounted on a target component of a target device, and clean and divide the vibration signals to obtain a target vibration signal.

The first determining unit 52 is configured to input the target vibration signal to a target abnormality determining model, to obtain an output result, and determine, according to the output result, whether the target vibration signal is abnormal, to obtain an abnormality determination result, where the target abnormality determining model is obtained by training sample vibration signals of the target component, and the target abnormality determining model includes an encoder and a decoder.

The prediction unit 53 is configured to input, in a case that the abnormality determination result represents that the target vibration signal is abnormal, the target vibration signal to a target fault prediction model, to obtain a fault prediction result, where the target fault prediction model is obtained by combining the encoder of the target abnormality determining model and a newly added fully-connected layer, and the target fault prediction model is obtained by training using a plurality of fault types and a vibration signal of each fault type as samples.

In the fault prediction apparatus provided in this embodiment of the present disclosure, the first obtaining unit 51 obtains vibration signals acquired by a sensor mounted on a target component of a target device, and cleans and divides the vibration signals to obtain a target vibration signal. The first determining unit 52 inputs the target vibration signal to a target abnormality determining model, to obtain an output result, and determines, according to the output result, whether the target vibration signal is abnormal, to obtain an abnormality determination result, where the target abnormality determining model is obtained by training sample vibration signals of the target component, and the target abnormality determining model includes an encoder and a decoder. The prediction unit 53 inputs, in a case that the abnormality determination result represents that the target vibration signal is abnormal, the target vibration signal to a target fault prediction model, to obtain a fault prediction result, where the target fault prediction model is obtained by combining the encoder of the target abnormality determining model and a newly added fully-connected layer, and the target fault prediction model is obtained by training using a plurality of fault types and a vibration signal of each fault type as samples. A problem in the related art that only when a device has an obvious fault, the fault can be detected and the faulty device cannot be maintained in time is resolved. After a vibration signal of a target component is preprocessed, a target abnormality determining model determines whether the acquired vibration signal is abnormal. In a case that an abnormality exists, a target fault prediction model determines a cause of the abnormality in the vibration signal, so that the two models may quickly determine whether the target component has a fault and determines a cause of the fault, thereby improving a fault monitoring speed and efficiency, and maintaining the target device according to the cause of the fault in time.

In some example implementations, in the fault prediction apparatus provided in this embodiment of the present disclosure, the first obtaining unit 51 includes: a division module, configured to divide the vibration signal according to a time dimension, to obtain a plurality of first vibration signals, where each first vibration signal includes vibration signals under a same duration, and the duration includes a plurality of continuous vibration periods; a determination module, configured to sequentially determine whether an error signal exists in the first vibration signals, where the error signal represents abnormal operation of the sensor; a deletion module, configured to delete, in a case that an error signal exists in a first vibration signal segment, the first vibration signal with the error signal from the plurality of first vibration signals, to obtain a plurality of second vibration signals; and an input module, configured to sequentially input the second vibration signals to a preset filter, to obtain a plurality of target vibration signals.

In some example implementations, in the fault prediction apparatus provided in this embodiment of the present disclosure, the target abnormality determining model is obtained by training through: a second obtaining unit, configured to obtain a sample vibration signal set of the target component, where the sample vibration signal set includes a plurality of sample vibration signals generated by the target component under normal operation; an input unit, configured to input the sample vibration signals in the sample vibration signal set to an initial abnormality determining model, to process the sample vibration signals and obtain an output signal corresponding to each of the sample vibration signals, where the initial abnormality determining model includes an encoder and a decoder, the encoder is configured to extract features of the sample vibration signals and reduce a data dimension, and the decoder is configured to recover the data dimension and recover a data feature; a second determining unit, configured to determine a difference value between each output signal and the corresponding sample vibration signal, to obtain a plurality of difference values, and determine whether a difference value that is greater than a preset threshold exists among the plurality of difference values; a conversion unit, configured to change a neuron connection weight in the initial abnormality determining model in a case that the difference value that is greater than the preset threshold exists among the plurality of difference values, and retrain the changed initial abnormality determining model until no difference value that is greater than the preset threshold exists among the plurality of difference values; and a third obtaining unit, configured to obtain the target abnormality determining model in a case that no difference value that is greater than the preset threshold exists among the plurality of difference values.

In some example implementations, in the fault prediction apparatus provided in this embodiment of the present disclosure, the first determining unit 52 includes: a first determining module, configured to determine a difference value between the output result and the target vibration signal, to obtain a target difference value, and determine whether the target difference value is greater than the preset threshold; a second determining module, configured to determine, in a case that the target difference value is greater than the preset threshold, that the target vibration signal is abnormal; and a third determining module, configured to determine, in a case that the target difference value is less than or equal to the preset threshold, that the target vibration signal is not abnormal.

In some example implementations, in the fault prediction apparatus provided in this embodiment of the present disclosure, the target fault prediction model is obtained by training through: a fourth obtaining unit, configured to obtain the plurality of fault types and a historical vibration signal under each of the fault types, to obtain a plurality of sets of historical vibration signals; an adding unit, configured to add a tag to each historical vibration signal in each set of historical vibration signals according to the fault type, to obtain a plurality of sets of updated historical vibration signals; and a training unit, configured to train an initial fault prediction model by using the plurality of sets of updated historical vibration signals as samples, to obtain the target fault prediction model.

In some example implementations, in the fault prediction apparatus provided in this embodiment of the present disclosure, the apparatus further includes: a fifth obtaining unit, configured to obtain a historical abnormal vibration signal acquired by the sensor when an anomaly occurs in the target component; a third determining unit, configured to determine feature information of the vibration signals of the target component according to the historical abnormal vibration signal, to obtain a plurality of pieces of feature information, and obtain a feature value corresponding to each piece of feature information; a fourth determining unit, configured to determine a determination criterion of each piece of feature information according to the feature value corresponding to each piece of feature information, to obtain a plurality of determination criteria; a determination unit, configured to obtain, from the target vibration signal, a vibration data value corresponding to each piece of feature information, and performing abnormality determining on the vibration data value by using a determination criterion of the same feature information, to obtain a determination result; and an alarm unit, configured to determine, in a case that the determination result represents that the target vibration signal is not abnormal, that an anomaly exists in the target abnormality determining model, and transmit alarm information, where the alarm information represents that an anomaly exists in the target abnormality determining model.

In some example implementations, in the fault prediction apparatus provided in this embodiment of the present disclosure, the determination unit includes: an obtaining module, configured to obtain the vibration data value under each piece of feature information and the determination criterion under the same feature information, and determine whether the vibration data value satisfies a corresponding determination criterion, to obtain a plurality of sub-determination results, where the sub-determination results are configured for representing whether the vibration data value satisfies the corresponding determination criterion; a fourth determining module, configured to determine, in a case that a sub-determination result that does not satisfy the determination criterion exists among the plurality of sub-determination results, that the determination result indicates that the target vibration signal is abnormal; and a fifth determining module, configured to determine, in a case that no sub-determination result that does not satisfy the determination criterion exists among the plurality of sub-determination results, that the determination result indicates that the target vibration signal is not abnormal.

The foregoing fault prediction apparatus includes a processor and a memory. The first obtaining unit 51, the first determining unit 52, the prediction unit 53, and the like are all stored in the memory as program units. The processor executes the program units stored in the memory to implement corresponding functions.

The processor includes a kernel. The kernel retrieves a corresponding program unit from the memory. One or more kernels may be provided. A parameter of the kernel is adjusted to resolve a problem in the related art that only when a device has an obvious fault, the fault can be detected and the faulty device cannot be maintained in time.

The memory may include a volatile memory in a computer-readable medium, a random access memory (RAM), and/or a non-volatile memory, such as a read-only memory (ROM) or a flash RAM. The memory includes at least one memory chip.

In the related art, a reciprocating device plays an important role in various industrial fields, and in particular, in the energy, chemical, and manufacturing industry. For example, a reciprocating compressor is widely applied to petroleum and natural gas extraction, chemical product manufacturing, and compression of air and other gases. To ensure continuity and production efficiency of a production process, the working efficiency and reliability of the reciprocating device are of great importance.

It should be noted that all components of the reciprocating device, such as a piston, a cylinder, a valve, a packing, and a valve body, are faulty due to long-time operation and wear. For example, if a piston ring of the reciprocating compressor is worn excessively, compression efficiency may be reduced, and even the compressor may be faulty.

Therefore, it is very necessary to monitor the health and integrity of the reciprocating device. Through regular maintenance and inspection, the fault of the device may be found and repaired in time, thereby avoiding damage to the device and interruption of the production process. This is very important to ensure effective operation of the energy industry and other industries.

Currently, when an operating condition of the reciprocating device is monitored, a device fault can usually be detected only when the fault occurs and obviously affects the operation of the device. Whether the reciprocating device is faulty can be determined only by an experienced technician by detecting conditions such as a sound and an appearance of the reciprocating device on a construction site, and normal work of the reciprocating device can be ensured in cooperation with a periodical check of a maintenance worker during operation. However, accuracy of manually identifying the reciprocating device mainly relies on experience of a technician, which easily causes problems such as misjudgment and missed judgment. In addition, a fault can be found only when an obvious impact is caused, and consequently, the fault cannot be found and handled in time and accurately.

Currently, no effective solution is provided to resolve a problem in the related art that timeliness and accuracy of manually determining whether a device has a fault are relatively low.

In view of this, the present disclosure further provides a fault monitoring method, to resolve the problem in the related art that timeliness and accuracy of manually determining whether a device has a fault are relatively low.

For ease of description, some nouns or terms related to the embodiments of the present disclosure are described below.

Key phase signal: A groove or a convex key is disposed on a measured axis, and serves as a key phase mark. When the mark rotates to a position of a probe, which is equivalent to an abrupt change in spacing between the probe and a measured surface, the sensor generates a pulse signal, and a signal generated when the axis rotates for multiple circles is a key phase signal.

According to an embodiment of the present disclosure, a fault monitoring method is provided.

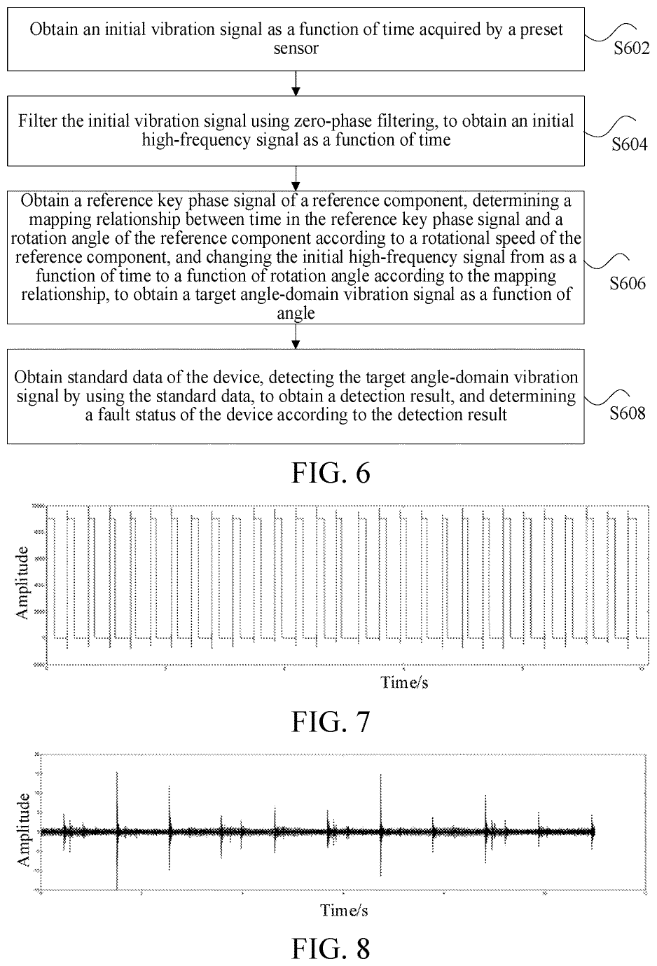

FIG. 6 is a flowchart of a fault monitoring method according to an embodiment of the present disclosure. As shown in FIG. 6, the method includes the following steps.
Step S602: Obtain an initial vibration signal acquired by a preset sensor, where the preset sensor is disposed at a target position on a target device, and the preset sensor is configured to acquire a vibration signal of the target position.

Specifically, the target device may be a reciprocating device. When the target device has a fault, a position where the fault occurs is relatively fixed, for example, a piston or a cylinder, and a vibration signal of a part of members during operation may feed back whether the operation of the device is abnormal. Therefore, a sensor may be mounted at a target position on the target device, so as to determine whether the target device has a fault according to a vibration signal, which is acquired by the sensor, at the target position during operation of the target device.
Step S604: Filter the initial vibration signal using zero-phase filtering, to obtain an initial high-frequency signal.

Specifically, after the vibration signal acquired by the sensor at the target position is received, noise may be mixed in the received vibration signal, affecting analysis of the vibration signal. Therefore, the noise in the vibration signal needs to be canceled or attenuated, so that signal availability and accuracy are relatively high.

It should be noted that when the vibration signal is filtered, an infinite impulse response filter is usually used, and a filter with a corresponding function, such as a low-pass filter, a high-pass filter, a band-pass filter, or a band-stop filter, is selected according to a filtering requirement. However, after the infinite impulse response filter processes a signal, the obtained signal has a delay, and has a small change in a signal waveform. Therefore, during filtering, the initial vibration signal needs to be filtered using zero-phase filtering, to obtain an initial high-frequency signal, thereby ensuring that the obtained high-frequency signal has no delay and waveform changes.
Step S606: Obtain a reference key phase signal of a reference device, determine a mapping relationship between time in the reference key phase signal and a rotation angle of the reference device according to a rotational speed of the reference device, and change a horizontal coordinate of the initial high-frequency signal from a time value to a corresponding angle value according to the mapping relationship, to obtain a target angle-domain vibration signal, where the rotational speed of the reference device is the same as a rotational speed of the target device. In other words, the initial high-frequency signal is a function of time. This process converts the initial high-frequency signal as a function of time to as a function of angle.

Specifically, after the initial high-frequency signal is obtained. The initial high-frequency signal is a relationship curve between an acquisition moment and an amplitude, and needs to be converted into a relationship curve between a rotation angle and an amplitude during analysis of an operating condition of the target device. Therefore, a mapping relationship between the rotation angle of the target device and the acquisition moment needs to be determined, so that a horizontal coordinate of the initial high-frequency signal is changed from a time value to a corresponding angle value according to the mapping relationship, to obtain the target angle-domain vibration signal.

Further, when the mapping relationship between the rotation angle of the target device and the acquisition moment is determined, because a relationship between a number of revolutions of the target device and a rotation time cannot be known, a reference key phase signal of the reference device may be obtained, and a relationship between time and the rotation angle may be determined according to the vibration signal of the reference device during operation. Because a rotational speed of the reference device is the same as that of the target device, time required for rotating by a same angle is the same. After a relationship between the number of revolutions of the reference device and the rotation time is obtained, the relationship may be determined as the mapping relationship between the number of revolutions of the target device and the rotation time, so as to complete conversion of the horizontal coordinate of the initial angle-domain vibration signal.

FIG. 7 is a schematic diagram of an example reference key phase signal according to an embodiment of the present disclosure. As shown in FIG. 7, an acquisition moment of each amplitude acquisition point may be seen from the figure, and because the key phase signal is amplitude acquisition performed when a reference assembly rotates to a position, a rotation angle between adjacent amplitudes is 360 degrees. Therefore, an acquisition moment per degree may be determined according to FIG. 2, to obtain a mapping relationship between time and a rotation angle.

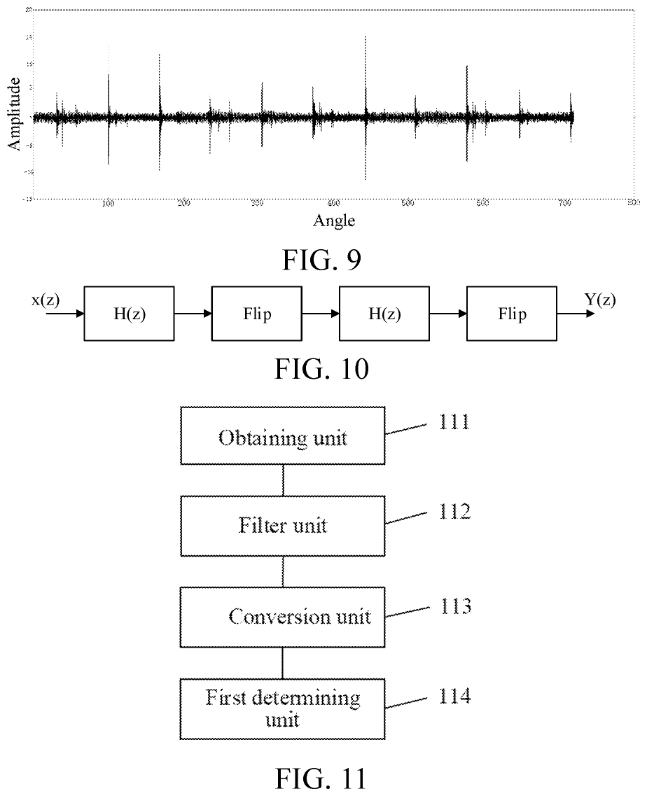

FIG. 8 is a schematic diagram of an example initial high-frequency signal according to an embodiment of the present disclosure. FIG. 9 is a schematic diagram of an example target angle-domain vibration signal according to an embodiment of the present disclosure. As shown in FIG. 8 and FIG. 9, FIG. 8 is a schematic diagram of an initial high-frequency signal. In this case, the signal is a time-domain signal, namely, a relationship curve between an amplitude and time. After being converted according to a mapping relationship between time and a rotation angle, an X axis is converted from an acquisition moment to a rotation angle, to obtain the target angle-domain vibration signal in FIG. 9.
Step S608: Obtain standard data of the target device, detect the target angle-domain vibration signal by using the standard data, to obtain a detection result, and determine a fault status of the target device according to the detection result, where the standard data is data in a vibration signal of the target device during normal operation.

Specifically, after the target angle-domain vibration signal is obtained, standard data of the target device may be obtained. The standard data may be an amplitude value corresponding to an important angle in the target device. For example, the standard data may be that: the amplitude cannot exceed 50 at the position of 180 degrees. Then, the amplitude of 180 degrees in the target angle-domain vibration signal may be compared with the standard data, to determine whether the amplitude in the target angle-domain vibration signal is a normal value. Further, it may be determined, according to whether an abnormal signal exists in the target angle-domain vibration signal and in the presence of an abnormal signal, that the operating condition of the target device is abnormal and needs to be maintained.

In the fault monitoring method provided in this embodiment of the present disclosure, an initial vibration signal acquired by a preset sensor is obtained, where the preset sensor is disposed at a target position on a target device, and the preset sensor is configured to acquire a vibration signal of the target position. The initial vibration signal is filtered using zero-phase filtering, to obtain an initial high-frequency signal. A reference key phase signal of a reference device is obtained, a mapping relationship between time in the reference key phase signal and a rotation angle of the reference device is determined according to a rotational speed of the reference device, and a horizontal coordinate of the initial high-frequency signal is changed from a time value to a corresponding angle value according to the mapping relationship, to obtain a target angle-domain vibration signal, where the rotational speed of the reference device is the same as a rotational speed of the target device. Standard data of the target device is obtained, the target angle-domain vibration signal is detected by using the standard data, to obtain a detection result, and a fault status of the target device is determined according to the detection result, where the standard data is data in a vibration signal of the target device during normal operation. A problem in the related art that timeliness and accuracy of manually determining whether a device has a fault are relatively low is resolved. The acquired signal is filtered using zero-phase filtering, and the time value of the vibration signal is changed to the angle value according to a mapping relationship between an angle and time, where Therefore, whether the vibration signal is abnormal may be determined according to the vibration data corresponding to the rotation angle, thereby improving a fault monitoring speed and accuracy.

In some example implementations, in the fault monitoring method provided in this embodiment of the present disclosure, the filtering the initial vibration signal using zero-phase filtering, to obtain the initial high-frequency signal includes: obtaining a preset high-pass filter, and inputting the initial vibration signal to the preset high-pass filter, to obtain a first time-domain signal; flipping the first time-domain signal about a center line of an X axis, and inputting the flipped first time-domain signal to the preset high-pass filter, to obtain a second time-domain signal; and flipping the second time-domain signal about the center line of the X axis, to obtain the initial high-frequency signal.

Specifically, to remove noise from the vibration signal and ensure accuracy of a processed signal, an infinite impulse response filter, such as a low-pass filter, a high-pass filter, a band-pass filter, or a band-stop filter, may be first designed according to the vibration signal and noise characteristics of the reciprocating device by using a double linear transformation method.

For example, assuming that useful bands of the reciprocating device are mostly concentrated above 1000 Hz and noise signals are mostly characterized by a gear mesh frequency (less than 1000 Hz) and a harmonic thereof and low-frequency (less than 500 Hz) noise interference, an infinite impulse response high-pass filter for filtering low-pass interference is designed by using the double linear transformation method.

Further, after the infinite impulse response high-pass filter processes a signal, the obtained signal has a delay, and has a small change in a signal waveform. Therefore, during filtering, the initial vibration signal needs to be filtered using zero-phase filtering, to obtain an initial high-frequency signal, thereby ensuring that the obtained high-frequency signal has no delay and waveform changes.

FIG. 10 is a flowchart of a zero-phase filtering manner according to an embodiment of the present disclosure. As shown in FIG. 10, an initial vibration signal x(z) is first input to an infinite impulse response high-pass filter H(z). Then, an obtained time-domain signal is flipped, to obtain a signal xH(z). The obtained signal xH(z) is passed through the filter H(z) again, to obtain a time-domain signal xHH(z). Finally, xHH(z) is flipped to obtain a signal Y(z) after zero-phase filtering, namely, an initial high-frequency signal. Therefore, an original waveform of a signal is ensured, and phase distortion is reduced.

It should be noted that the signal is flipped by using the following method: A center position of the signal on an X axis is obtained, a vertical line of the X axis is drawn to obtain a center line, and mirror flipping is performed along the center line, thereby completing a flipping operation on the signal.

In some example implementations, in the fault monitoring method provided in this embodiment of the present disclosure, after the obtaining the reference key phase signal of the reference device, the method further includes: determining a rotation period of the reference device according to the rotational speed of the reference device, and capturing a signal in a preset time period from the reference key phase signal, to obtain an updated reference key phase signal, where the preset time period includes a plurality of continuous rotation periods; and capturing a signal in the preset time period from the initial high-frequency signal, to obtain an updated initial high-frequency signal. The determining the mapping relationship between the time in the reference key phase signal and the rotation angle of the reference device according to the rotational speed of the reference device, and changing the horizontal coordinate of the initial high-frequency signal from the time value to the corresponding angle value according to the mapping relationship, to obtain the target angle-domain vibration signal includes: determining a mapping relationship between time in the updated reference key phase signal and the rotation angle of the reference device according to the rotational speed of the reference device, and converting the updated initial high-frequency signal according to the mapping relationship, to obtain the target angle-domain vibration signal.

Specifically, when the signal is analyzed, to improve a signal analysis speed, a rotation period of the reference device may be determined according to a rotational speed of the reference device. For example, if the rotational speed is one revolution per second, the rotation period is 1 s, and a signal in a preset time period is captured from the reference key phase signal according to 1 s. The preset time period may be a plurality of rotation periods. For example, a signal within 1 minute is captured.

Further, to change a value of the X axis in the initial high-frequency signal according to a relationship between the rotational speed and time, the high-frequency vibration signal in the preset time period also needs to be captured, to obtain an updated high-frequency vibration signal. It should be noted that capturing time periods of the captured high-frequency vibration signal and the captured reference key phase signal are the same, and a start moment and an end moment also need to be the same. After the captured high-frequency vibration signal is obtained, an angle corresponding to each acquisition moment may be determined according to the mapping relationship, so that a time axis in the high-frequency vibration signal is changed to an angle axis, to obtain the target angle-domain vibration signal.

In some example implementations, in the fault monitoring method provided in this embodiment of the present disclosure, the reference device is provided with an encoder disc, and the rotational speed of the reference device is the same as a rotational speed of the encoder disc. The determining the mapping relationship between the time in the reference key phase signal and the rotation angle of the reference device according to the rotational speed of the reference device includes: determining, according to the rotational speed, a number of revolutions of the encoder disc in the preset time period, to obtain a preset number of revolutions; and determining a rotation angle corresponding to the preset number of revolutions, and determining, according to the rotation angle and the preset time period, a duration required for rotating by 1 degree, to obtain the mapping relationship.

Specifically, when the mapping relationship between the time and the rotation angle is determined, a length of time required for each revolution of the reference device may be determined by using the encoder disc, to determine a length of time required for the reference device to rotate by 1 degree, so that a rotation degree of the reference device corresponding to each acquisition moment may be determined according to the length of time required for rotating by 1 degree.

For example, if the target device rotates by 1 degree per second, the target device rotates by one revolution in 360 s. In a case that the acquisition frequency is one acquisition per 2 s, the X axis of the reference device is changed from 1 s, 2 s, . . . to 2°, 4°, . . . .

In some example implementations, in the fault monitoring method provided in this embodiment of the present disclosure, the changing the horizontal coordinate of the initial high-frequency signal from the time value to the corresponding angle value according to the mapping relationship, to obtain the target angle-domain vibration signal includes: converting moment values in a time axis of the initial high-frequency signal to preset angle values according to the mapping relationship, to obtain an initial angle-domain vibration signal; and determining whether each of the preset angle values has a corresponding amplitude value in the initial angle-domain vibration signal, obtaining, in a case that a target preset angle value does not have a corresponding amplitude value, a plurality of preset angle values neighboring to the target preset angle value and an amplitude value of each of the preset angle values, calculating an amplitude value of the target preset angle value according to the amplitude value of each of the preset angle values by using an interpolation method, and adding the amplitudes to corresponding positions in the initial angle-domain vibration signal, to obtain the target angle-domain vibration signal.

It should be noted that when the target angle-domain vibration signal is analyzed, amplitude values at particular angles need to be obtained. However, due to setting of the acquisition frequency, it may occur that no amplitude value is acquired at a moment corresponding to an angle. Consequently, an amplitude value at the particular angle cannot be obtained, and further, whether the target device is abnormal cannot be determined according to the amplitude value.

Specifically, after the time value is converted into the angle value according to the mapping relationship, in a case that a particular angle has no corresponding amplitude value, amplitude values of a plurality of preset angle values neighboring to the particular angle may be used, an amplitude value at the particular angle is calculated by using an interpolation algorithm according to the amplitude values of the plurality of neighboring preset angle values, and the amplitude value is added to the initial angle-domain vibration signal, to obtain a target angle-domain vibration signal with an entire amplitude value.

For example, high-frequency data Hi{hi0, hi1, hi2, . . . , hin} and key phase signals Ki{ki1, ki2, ki3, . . . , kin} within a same time period [t1, t2] (or two periods) are adopted. First, the key phase signal needs to be interpolated to obtain angle-domain data within the two periods. To be specific, a horizontal coordinate of the key phase signal is converted from original time to an angle, and time corresponding to each angle is calculated. For example, if an angle interval after the conversion is 1°, time TAi{ta1, ta2, ta3, . . . , tan} and a vertical coordinate Kai{ka1, ka2, ka3, . . . , kan} corresponding to 1°, 2°, 3° . . . , and 720° need to be obtained. Corresponding values of TAi and Kai both need to be calculated by using interpolation functions. The high-frequency data Hi is converted into an angle-domain signal Ph{ph1, ph2, ph3, . . . , phn} by using the time information Tai calculated above and by using a same interpolation calculation step, so as to obtain the target angle-domain vibration signal.

In some example implementations, in the fault monitoring method provided in this embodiment of the present disclosure, the detecting the target angle-domain vibration signal by using the standard data, to obtain the detection result, and determining the fault status of the target device according to the detection result includes: obtaining a verification angle and a standard amplitude at the verification angle from the standard data; determining an amplitude at the verification angle in the target angle-domain vibration signal to obtain a target amplitude, and determining whether the target amplitude is greater than the standard amplitude; determining, in a case that the target amplitude is greater than the standard amplitude, that the target device has a fault; and determining, in a case that the target amplitude is less than or equal to the standard amplitude, that the target device does not have a fault.

Specifically, when the target angle-domain vibration signal is detected, standard data needs to be first obtained. The standard data may be an amplitude value corresponding to an important angle in the target device. For example, the standard data may be that: At a position of 180 degrees, the amplitude cannot be more than 50, and after the standard data is obtained, a plurality of verification angles may be obtained from the standard data. An amplitude value at each verification angle needs to satisfy a corresponding verification requirement.

Further, after the plurality of verification angles and the standard amplitude at each verification angle are obtained, an amplitude at each verification angle may be obtained from the target angle-domain vibration signal, to obtain a plurality of target amplitudes, and the target amplitude and the standard amplitude at the same verification angle are compared. When the target amplitude is greater than the standard amplitude, it may represent that the target device has a fault. In this way, the fault status of the target device can be determined according to the amplitude.

In some example implementations, in the fault monitoring method provided in this embodiment of the present disclosure, the determining the amplitude at the verification angle in the target angle-domain vibration signal to obtain the target amplitude includes: obtaining an angle range in the target angle-domain vibration signal, and obtaining a number of rotation periods included in the angle range, to obtain a number of periods, where the angle range is greater than 360 degrees; calculating an angle value corresponding to the verification angle in each period, to obtain a plurality of preset angles; and determining a target angle corresponding to each preset angle in the target angle-domain vibration signal, to obtain a plurality of target angles, and obtaining an amplitude at each target angle, to obtain a plurality of target amplitudes.

Specifically, the verification angle in the standard data falls within a range of 0 to 360 degrees, but as shown in FIG. 4, the obtained angle range of the target angle-domain vibration signal is greater than 360 degrees. In this case, a rotation period corresponding to the angle range needs to be determined. For example, if the angle range of the target angle-domain vibration signal is 0 degrees to 720 degrees, the number of rotation periods is calculated to be 720/360=2. To be specific, there are two rotation periods. An angle value corresponding to the verification angle in each period is calculated according to the number of rotation periods. For example, the verification angle in a first period is 180°, and the verification angle in a second period is 540°, so that an amplitude value at 540° may be obtained from the target angle-domain vibration signal. The amplitude value at 540° is compared with the standard amplitude at the verification angle, to obtain a comparison result, so as to compare amplitude values at target angles in the entire target angle-domain vibration signal, thereby determining whether the vibration signal is abnormal, and further determining, according to an abnormality determination result, whether the target device is abnormal.

For example, when the verification angle is 100 degrees, the standard amplitude is 50, and the target amplitude is 100. In this case, the target amplitude is greater than the standard amplitude, and the verification angle corresponds to a lower valve body. In this case, it may represent that the lower valve body in the target device is abnormal.

It should be noted that the steps shown in the flowchart of the accompanying drawings may be performed, for example, in a computer system storing a set of computer-executable instructions. In addition, although a logic order is shown in the flowchart, in some cases, the shown or described steps may be performed in an order different from the order herein.

An embodiment of the present disclosure further provides a fault monitoring apparatus. It should be noted that the fault monitoring apparatus according to this embodiment of the present disclosure may be configured to perform the fault monitoring method according to the foregoing embodiment of the present disclosure. The following describes the fault monitoring apparatus provided in this embodiment of the present disclosure.

FIG. 11 is a schematic diagram of a fault monitoring apparatus according to an embodiment of the present disclosure. As shown in FIG. 11, the apparatus includes: an obtaining unit 111, a filter unit 112, a conversion unit 113, and a first determining unit 114.

The obtaining unit 111 is configured to obtain an initial vibration signal acquired by a preset sensor, where the preset sensor is disposed at a target position on a target device, and the preset sensor is configured to acquire a vibration signal of the target position.

The filter unit 112 is configured to filter the initial vibration signal using zero-phase filtering, to obtain an initial high-frequency signal.

The conversion unit 113 is configured to obtain a reference key phase signal of a reference device, determine a mapping relationship between time in the reference key phase signal and a rotation angle of the reference device according to a rotational speed of the reference device, and change a horizontal coordinate of the initial high-frequency signal from a time value to a corresponding angle value according to the mapping relationship, to obtain a target angle-domain vibration signal, where the rotational speed of the reference device is the same as a rotational speed of the target device.

The first determining unit 114 is configured to obtain standard data of the target device, detect the target angle-domain vibration signal by using the standard data, to obtain a detection result, and determine a fault status of the target device according to the detection result, where the standard data is data in a vibration signal of the target device during normal operation.

In fault monitoring apparatus provided in this embodiment of the present disclosure, the obtaining unit 111 is configured to obtain an initial vibration signal acquired by a preset sensor, where the preset sensor is disposed at a target position on a target device, and the preset sensor is configured to acquire a vibration signal of the target position. The filter unit 112 is configured to filter the initial vibration signal using zero-phase filtering, to obtain an initial high-frequency signal. The conversion unit 113 is configured to obtain a reference key phase signal of a reference device, determine a mapping relationship between time in the reference key phase signal and a rotation angle of the reference device according to a rotational speed of the reference device, and change a horizontal coordinate of the initial high-frequency signal from a time value to a corresponding angle value according to the mapping relationship, to obtain a target angle-domain vibration signal, where the rotational speed of the reference device is the same as a rotational speed of the target device. The first determining unit 114 is configured to obtain standard data of the target device, detect the target angle-domain vibration signal by using the standard data, to obtain a detection result, and determine a fault status of the target device according to the detection result, where the standard data is data in a vibration signal of the target device during normal operation, thereby resolving a problem in the related art that timeliness and accuracy of manually determining whether a device has a fault are relatively low. The acquired signal is filtered using zero-phase filtering, and the time value of the vibration signal is changed to the angle value according to a mapping relationship between an angle and time, where Therefore, whether the vibration signal is abnormal may be determined according to the vibration data corresponding to the rotation angle, thereby improving a fault monitoring speed and accuracy.

In some example implementations, in the fault monitoring apparatus provided in this embodiment of the present disclosure, the filter unit 112 includes: a first obtaining module, configured to obtain a preset high-pass filter, and input the initial vibration signal to the preset high-pass filter, to obtain a first time-domain signal; a first flipping module, configured to flip the first time-domain signal about a center line of an X axis, and input the flipped first time-domain signal to the preset high-pass filter, to obtain a second time-domain signal; and a second flipping module, configured to flip the second time-domain signal about the center line of the X axis, to obtain the initial high-frequency signal.

In some example implementations, in the fault monitoring apparatus provided in this embodiment of the present disclosure, the apparatus further includes: a second determining unit, configured to determine a rotation period of the reference device according to the rotational speed of the reference device, and capture a signal in a preset time period from the reference key phase signal, to obtain an updated reference key phase signal, where the preset time period includes a plurality of continuous rotation periods; and a capture unit, configured to capture a signal in the preset time period from the initial high-frequency signal, to obtain an updated initial high-frequency signal. The conversion unit 113 includes: a conversion module, configured to determine a mapping relationship between time in the updated reference key phase signal and the rotation angle of the reference device according to the rotational speed of the reference device, and convert the updated initial high-frequency signal according to the mapping relationship, to obtain the target angle-domain vibration signal.

In some example implementations, in the fault monitoring apparatus provided in this embodiment of the present disclosure, the reference device is provided with an encoder disc, and a rotational speed of the reference device is the same as a rotational speed of the encoder disc. The conversion unit 113 includes: a first determining module, configured to determine, according to the rotational speed, a number of revolutions of the encoder disc in the preset time period, to obtain a preset number of revolutions; and a second determining module, configured to determine a rotation angle corresponding to the preset number of revolutions, and determine, according to the rotation angle and the preset time period, a duration required for rotating by 1 degree, to obtain the mapping relationship.

In some example implementations, in the fault monitoring apparatus provided in this embodiment of the present disclosure, the conversion unit 113 includes: a second conversion module, configured to convert moment values in a time axis of the initial high-frequency signal to preset angle values according to the mapping relationship, to obtain an initial angle-domain vibration signal; and an interpolation module, configured to determine whether each of the preset angle values has a corresponding amplitude value in the initial angle-domain vibration signal, obtain, in a case that a target preset angle value does not have a corresponding amplitude value, a plurality of preset angle values neighboring to the target preset angle value and an amplitude value of each of the preset angle values, calculate an amplitude value of the target preset angle value according to the amplitude value of each of the preset angle values by using an interpolation method, and add the amplitudes to corresponding positions in the initial angle-domain vibration signal, to obtain the target angle-domain vibration signal.

In some example implementations, in the fault monitoring apparatus provided in this embodiment of the present disclosure, the first determining unit 114 includes: a second obtaining module, configured to obtain a verification angle and a standard amplitude at the verification angle from the standard data; a third determining module, configured to determine an amplitude at the verification angle in the target angle-domain vibration signal to obtain a target amplitude, and determine whether the target amplitude is greater than the standard amplitude; a fourth determining module, configured to determine, in a case that the target amplitude is greater than the standard amplitude, that the target device has a fault; and a fifth determining module, configured to determine, in a case that the target amplitude is less than or equal to the standard amplitude, that the target device does not have a fault.

In some example implementations, in the fault monitoring apparatus provided in this embodiment of the present disclosure, the third determining module includes: an obtaining submodule, configured to obtain an angle range in the target angle-domain vibration signal, and obtain a number of rotation periods included in the angle range, to obtain a number of periods, where the angle range is greater than 360 degrees; a calculation submodule, configured to calculate an angle value corresponding to the verification angle in each period, to obtain a plurality of preset angles; and a determining submodule, configured to determine a target angle corresponding to each preset angle in the target angle-domain vibration signal, to obtain a plurality of target angles, and obtain an amplitude at each target angle, to obtain a plurality of target amplitudes.

The foregoing fault monitoring apparatus includes a processor and a memory. The obtaining unit 111, the filter unit 112, the conversion unit 113, the first determining unit 114, and the like are all stored in the memory as program units. The processor executes the program units stored in the memory to implement corresponding functions.

The processor includes a kernel. The kernel retrieves a corresponding program unit from the memory. One or more kernels may be provided. A parameter of the kernel is adjusted to resolve a problem in the related art that timeliness and accuracy of manually determining whether a device has a fault are relatively low.

The memory may include a volatile memory in a computer-readable medium, a RAM, and/or a non-volatile memory, such as a ROM or a flash RAM. The memory includes at least one memory chip.

In the related art, dynamic equipment dominated by reciprocating devices and rotating devices plays a vital role in industrial application. A body of the dynamic equipment generally includes: a power unit, a transmission unit, and an execution unit. The power unit includes a motor, a piston engine, a steam turbine, and the like. The transmission unit includes a coupling, a gear box, and the like. The execution unit includes a centrifugal compressor, a centrifugal pump, a reciprocating compressor, a reciprocating pump, and the like. The foregoing structure of the dynamic equipment is complex, and the dynamic equipment generally performs high-strength operations in a severe environment, which is prone to component fatigue failure, sudden fault, or the like. If the component fatigue failure or the sudden fault cannot be found and processed in advance, production efficiency is seriously affected, and production costs and operation and maintenance costs are increased.

In view of this, in the related art, various types of sensor data are usually acquired to generate a signal time-frequency graph, and a fault is found based on expert experience or contrastive analysis. However, overall fault early-warning timeliness of this method is not high enough, fault identification relies on expert experience, and diagnosis and repair costs are relatively high.

In view of this, the present disclosure provides a fault monitoring method for dynamic equipment, to resolve technical problems in the related art that overall fault early-warning timeliness of a method for acquiring various types of sensor data to generate a signal time-frequency graph and finding a fault based on expert experience or contrastive analysis is not high enough, fault identification relies on expert experience, and diagnosis and repair costs are relatively high.

To resolve technical problems in the related art that overall fault early-warning timeliness of a method for acquiring various types of sensor data to generate a signal time-frequency graph and finding a fault based on expert experience or contrastive analysis is not high enough, fault identification relies on expert experience, and diagnosis and repair costs are relatively high, the present disclosure provides a fault monitoring method and apparatus for dynamic equipment, an electronic device, and a storage medium. A fault of dynamic equipment can be detected in real time, and a fault point and a fault type of the dynamic equipment can be determined in a case that an operating fault of the dynamic equipment is detected, thereby finding the operating fault of the dynamic equipment in time, diagnosing the fault, reducing diagnosis and repair costs, and improving user experience.

For ease of understanding the fault monitoring method for dynamic equipment provided in this embodiment of the present disclosure, the following first describes, by using an example, a fault monitoring system for dynamic equipment according to an embodiment of the present disclosure.

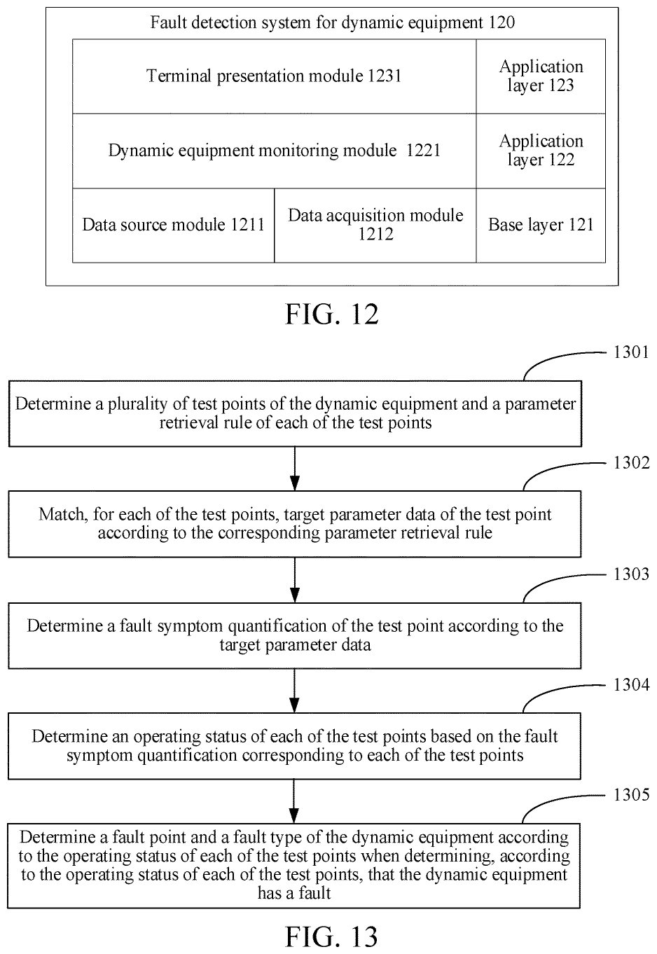

Refer to FIG. 12, which is a schematic structural diagram of a fault monitoring system for dynamic equipment according to an embodiment of the present disclosure. As shown in FIG. 12, the fault monitoring system 120 for dynamic equipment may include: a base layer 121, a function layer 122, and an application layer 123.

The base layer 121 may include, but is not limited to, a data source module 1211 and a data acquisition module 1212. The data source module 1211 may be a database for storing basic operating parameter data of a target dynamic equipment. The data acquisition module 1212 may be configured to acquire the basic operating parameter data of the target dynamic equipment, and transmit the acquired basic operating parameter data to the data source module 1211 for storage.

In some example implementations, the basic operating parameter data of the target dynamic equipment may include, but is not limited to: static attribute data of the target dynamic equipment, maintenance record data of the target dynamic equipment, operating data of the target dynamic equipment, and sensor signal data of the target dynamic equipment acquired by using sensor(s).

The function layer 122 may include, but is not limited to, dynamic equipment monitoring module 1221. The dynamic equipment monitoring module 1221 may obtain the basic operating parameter data of the target dynamic equipment stored in the data source module 1211, and perform, according to the obtained basic operating parameter data, fault monitoring on the target dynamic equipment by using the fault monitoring method for dynamic equipment provided in the foregoing embodiment of the present disclosure.

The application layer 123 may include, but is not limited to, a terminal presentation module 1231. The terminal presentation module 1231 may be configured to present a fault monitoring condition of the target dynamic equipment, and present a fault point and a fault type of the target dynamic equipment by using a terminal in a case that a fault of the target dynamic equipment is detected.

In this embodiment of the present disclosure, an execution entity of this embodiment of the present disclosure may be the dynamic equipment monitoring module 1221 of the function layer 122, which may obtain the basic operating parameter data of the target dynamic equipment stored in the base layer 121, and perform fault monitoring on the target dynamic equipment by using the fault monitoring method for dynamic equipment provided in the foregoing embodiment of the present disclosure.

The following further describes the fault monitoring method for dynamic equipment provided in the present disclosure by using specific embodiments with reference to the accompanying drawings. The embodiments do not constitute a limitation to the embodiments of the present disclosure.

Refer to FIG. 13, which is a flowchart of an embodiment of a fault monitoring method for dynamic equipment according to an embodiment of the present disclosure. The procedure shown in FIG. 13 may be applied to a fault monitoring system for dynamic equipment, for example, the fault monitoring system 120 for dynamic equipment shown in FIG. 12. As shown in FIG. 13, the procedure may include the following steps.

Step 1301: Determine a plurality of test points of a target dynamic equipment and a parameter retrieval rule of each of the test points.

The target dynamic equipment is dynamic equipment on which fault monitoring is to be performed, which may include but is not limited to: a power unit, a transmission unit, and an execution unit. The power unit includes a motor, a piston engine, a steam turbine, and the like. The transmission unit includes a coupling, a gear box, and the like. The execution unit includes a centrifugal compressor, a centrifugal pump, a reciprocating compressor, a reciprocating pump, and the like.

The test point refers to a position at which a tested target dynamic equipment may have a fault, or a key position on the target dynamic equipment. Whether the target dynamic equipment has a fault may be determined by testing an operating status of the key position. For example, the test point may be the motor, the piston engine, the reciprocating pump, or the like of the dynamic equipment.

The parameter retrieval rule refers to a correspondence between each of the test points and corresponding parameter data. The target parameter data corresponding to each of the test points may be determined by using the correspondence.

In an embodiment, a user may predetermine test points of a to-be-monitored target dynamic equipment, and input position information of the test points on the target dynamic equipment and a parameter retrieval rule of each of the test points to an execution entity of this embodiment of the present disclosure by using a visual interface.

Based on this, the execution entity of this embodiment of the present disclosure may determine, by using the visual interface, a plurality of test points on the target dynamic equipment and a correspondence between position information of each of the test points and a parameter retrieval rule.

Based on this, the execution entity of this embodiment of the present disclosure may obtain position information of each of the test points on the target dynamic equipment, and determine a parameter retrieval rule of each of the test points from the correspondence according to the position information.
Step 1302: Match, for each of the test points, target parameter data of the test point according to the corresponding parameter retrieval rule.

The target parameter data is parameter data corresponding to each of the test points, and may include, but is not limited to: static attribute data of the target dynamic equipment, maintenance record data of the target dynamic equipment, operating data of the target dynamic equipment, and sensor signal data of the target dynamic equipment acquired by using sensor(s).

In an embodiment, after determining the plurality of test points on the target dynamic equipment and the parameter retrieval rule of each of the test points, the execution entity of this embodiment of the present disclosure may match, for each of the test points, target parameter data of the test point according to the corresponding parameter retrieval rule.

As an example implementation, the execution entity of this embodiment of the present disclosure may obtain, for each of the test points, the target parameter data corresponding to the test point from a preset database (for example, the data source module 1211 shown in FIG. 1) according to the corresponding parameter retrieval rule. The database may pre-store the following several types of parameter data of the target dynamic equipment: static attribute data of the target dynamic equipment, maintenance record data of the target dynamic equipment, operating data of the target dynamic equipment, and sensor signal data of the target dynamic equipment acquired by using sensor(s).

Specifically, the static attribute data of the target dynamic equipment may include, but is not limited to: static file attribute data such as a device name, a device production date, a device commissioning date, and various rated device parameters.

The maintenance record data of the target dynamic equipment may include, but is not limited to: device maintenance and repair information data such as daily device maintenance and repair time, a maintenance person in charge, and degree of damage to maintenance parts and accessories.

The operating data of the target dynamic equipment may include, but is not limited to: instrument operation record data such as a rotational speed, a sand ratio, a total pressure, displacement, and power during device operation, where the acquisition frequency is generally low, but the data may directly respond to the current start, stop or operating status of the target dynamic equipment.

The sensor signal data of the target dynamic equipment acquired by the sensor may be a sensor signal for monitoring operation of the dynamic equipment and analyzing a physical parameter change, which may include, but is not limited to: vibration, temperature, pressure, or voiceprint.

In some example implementations, because types of sensors for monitoring different devices such as the dynamic equipment and the reciprocating device also differ, the foregoing sensor may include, but is not limited to: a rotation component vibration sensor or sensor hardware capable of monitoring a device operating status signal such as a reciprocating component key phase, vibration, temperature, and pressure sensor.

Further, the target dynamic equipment may be pre-equipped with a plurality of sensors, which may be mounted at a plurality of test points on the target dynamic equipment, or may be mounted at other positions of the target dynamic equipment. This is not limited in this embodiment of the present disclosure. Based on this, the execution entity of this embodiment of the present disclosure may obtain a preset sensor acquisition rule, and control, according to the sensor acquisition rule, corresponding sensor(s) to acquire corresponding sensor signal data. Then, the acquired sensor signal data may be stored to the database, and the data stored in the database is updated in time. The sensor acquisition rule may be an acquisition mode preset by a user: For example, acquisition is synchronously performed at an interval of 60 seconds, and acquisition is triggered when a speed of a crankshaft is greater than 10 revolutions or a vibration feature value is greater than 1 mm/s. A sampling frequency is 25600 Hz. A quantity of sampling points is 102400. A sensor sensitivity is 100 mv/g.

For example, a manner of obtaining sensor data is described below by using an example in which vibration, pressure, and temperature sensors of a reciprocating plunger pump are mounted:

First, the vibration sensor may be mounted on a radial portion and an axial portion of each bearing housing of a reduction box (or another rotation component) by threading or magnetic attraction.

Second, a key phase toothed disk is mounted on a power end crankshaft or a rotating component connected to the crankshaft, and rotates and moves with the crankshaft. A key phase sensor is mounted, by using a bracket, on the power end crankshaft or a support component connected to the crankshaft, and does not rotate and move with the crankshaft. The key phase toothed disk has N teeth, where (N−1) teeth are evenly distributed, and a tooth angle is 360°/N. The remaining tooth has a different shape. To be specific, the tooth is concave or convex. The tooth is configured for defining a zero-point position, and is briefly referred to as a zero-point tooth. By this method, the speed of the crankshaft and a rotation angle of the crankshaft (where the angle is associated with a travel of a piston) may be obtained, and the obtained angle value is used as a horizontal coordinate to calibrate a change condition of another signal (such as vibration, temperature, or pressure).

A turning gear causes cylinder 1 to be at a top-dead-center position. The zero-point tooth is accurately aligned with the key phase sensor. Because an angle difference between the cylinders is fixed, each cylinder has a zero-point angle reference when acquiring a sensor signal.

Third, the vibration sensor is mounted on a radial portion and an axial portion of a bearing housing of a crankcase, a crosshead load region, and a vertical direction of a packing cavity by threading or magnetic attraction.

Fourth, the temperature sensor is mounted in the crosshead load region by threading or magnetic attraction, and monitors a temperature of a crosshead component. Alternatively, a temperature-vibration integrated sensor may be used.

Fifth, the pressure sensor may be mounted on a suction gland by threading, to monitor a real-time dynamic pressure inside a valve box cavity.
Step 1303: Determine a fault symptom quantification of the test point according to the target parameter data.

The fault symptom quantification refers to a fault symptom variable or factor that can have a strong association relationship with a fault of the device. Each of the test points may correspond to one or more fault symptom quantities. This is not limited in this embodiment of the present disclosure.

In an embodiment, after determining the target parameter data corresponding to each of the test points on the target dynamic equipment, the execution entity of this embodiment of the present disclosure may determine, for each of the test points, a fault symptom quantification of the test point according to the target parameter data corresponding to the test point.

As an example implementation, the execution entity of this embodiment of the present disclosure may determine position information of each of the test points, and determine, according to the position information of the test point, a feature value calculation rule and a fault symptom quantification calculation rule corresponding to the test point. The feature value calculation rule and the fault symptom quantification calculation rule may be calculation rules input by a user in advance.

Based on this, for each of the test points, the execution entity of this embodiment of the present disclosure may calculate, according to the feature value calculation rule, the target parameter data corresponding to the test point, to obtain at least one feature value corresponding to the test point.

The feature value refers to indicator data that is calculated or extracted by performing a series of numerical transformations on the target parameter data and that can reflect a main distribution feature of data. The feature value may include but is not limited to the following types:

First, the target dynamic equipment calculates, within each operating period, a time-domain feature value, which may include but is not limited to: an effective value, a maximum value, a minimum value, an average value, an average amplitude, a peak-to-peak value, a kurtosis value, a skewness value, a square amplitude, a peak factor, a pulse factor, a waveform factor, and a margin factor.

Second, the target dynamic equipment calculates, within each operating period, a feature value of each angle segment according to angle-domain segments, which may include but is not limited to: an effective value, a maximum value, a minimum value, an average value, an average amplitude, a peak-to-peak value, a kurtosis value, a skewness value, a square amplitude, a peak factor, a pulse factor, a waveform factor, and a margin factor.

For example, according to an initial phase zero-point position of a key phase signal, an entire period vibration signal of one working cycle of a 1V test point at a cylinder 1 packing may be extracted. By using an interpolation algorithm (which includes but is not limited to a diversified strip interpolation algorithm and a Lagrange interpolation algorithm), equally-spaced vibration time-domain signals are converted into equally-spaced vibration angle-domain signals according to crankshaft angle segments of 0° to 360°. An angle-domain effective value is calculated according to every 10° or another angle segment.

Third, fast Fourier transform is performed on the sensor signal to obtain a frequency-domain signal, filtering is performed according to different fixed bands, and feature values of different bands are calculated.

For example, assuming that an analysis frequency range of the original vibration signal is 0 to 12800 Hz, band-pass filtering may be performed according to 0 to 2 Hz, 2 to 1000 Hz, and 1000 to 12800 Hz, to calculate an effective value of the corresponding band. 0 to 2 Hz may reflect whether the sensor generates a ski slope and whether the sensor works normally. 2 to 1000 Hz may reflect a low-frequency fault of a unit, such as imbalance or misalignment. 1000 to 12800 Hz may reflect a high-frequency fault of the unit, such as wear of a bearing or a gear.

Fourth, a corresponding motor rotation frequency, a gear box parallel rotation frequency, a gear box planetary rotation frequency, a crankshaft rotation frequency, and a gear box meshing frequency may be calculated based on a transmission ratio of a transmission chain and a bearing model and according to the speed of the crankshaft. Fast Fourier transform is performed on signals of vibration sensors of the gear box and the crankcase to obtain a frequency-domain signal, windowing function filtering is performed on the frequency-domain signal according to the foregoing frequencies, and feature values of the corresponding frequencies are calculated for the filtered signal.

Then, data combination may be performed on the target parameter data and/or the feature value according to the fault symptom quantification calculation rule, to generate the fault symptom quantification of the test point. The fault symptom quantification may include, but is not limited to: a rotating-type component fault symptom quantification, a leakage-type fault symptom quantification, a sensor abnormality symptom quantity, a fault identification symptom quantity of data-driven modeling, and a baseline space overlimit symptom quantity. For the rotating-type component fault symptom quantification, a fault symptom quantification responding to faults of different types of rotating components is obtained by performing combined calculation (a combined calculation manner includes, but is not limited to, summation, subtraction, integration, and differentiation) on frequencies such as a bearing rotation frequency, a gear meshing frequency, and a frequency sideband, a harmonic frequency, or different bands. The creating a rotating-type fault symptom quantification includes, but is not limited to: a bearing factor (capable of reflecting a fault status such as imbalance of a bearing); a bearing bush factor (capable of reflecting a fault status of a large-end bush); a parallel load factor, and a planetary load factor (capable of reflecting a misalignment fault status of an axis system); and a sideband factor (capable of reflecting a gear damage status).

For the leakage-type fault symptom quantification, a fault symptom quantification responding to a leakage fault in a cylinder is obtained by performing combined calculation (a combined calculation manner includes, but is not limited to, summation, subtraction, integration, and differentiation) on a particular band or frequency of an in-cylinder vibration signal in a process of device reciprocation. The creating a leakage-type fault symptom quantification includes, but is not limited to: an effective leakage factor, an energy leakage factor, and an acceleration leakage factor (capable of reflecting a fault status caused by leakage of a sealing member such as a check valve in a cylinder).

For the sensor abnormality symptom quantity, a symptom quantity that can respond to a sensor abnormality is obtained by calculating feature indicators that have a strong association relationship with a sensor status, such as an energy value and a bias voltage value in a specified band of signal frequency-domain data, and performing combined calculation (a combined calculation manner includes, but is not limited to, summation, subtraction, integration, and differentiation).

The fault identification symptom quantity of data-driven modeling is a fault identification symptom quantity established by using an algorithm such as unsupervised machine learning and based on a normal unit signal collected in a laboratory or on a working site. Fault status and health status identification errors may be output and a determination result may be output for a specified test point.

For example, historical vibration signal data (a data acquisition manner is acquisition at an interval of 60 seconds, a sampling frequency is 25600 Hz, and a quantity of sampling points is 102400) of a test point at a gearwheel input side of a reduction gearbox of a plunger pump in a device health status may be obtained. Fast Fourier transform is performed on sample data per minute, original frequency-domain data per minute is used as training sample data, and a symmetric autoencoder neural network model based on a one-dimensional CNN layer is constructed. The training sample data is input, and iterative model training is performed in batches. To-be-tested vibration data is input to the model, so that a fault identification error may be output. The error item is the fault identification symptom quantity of the test point.

For the baseline space overlimit symptom quantity, a probability distribution space, briefly referred to as baseline space, in a time domain or a frequency domain may be constructed based on a normal unit signal collected in a laboratory or on a working site. A signal is input to the baseline space, to obtain a difference distribution between the input signal and the baseline space. The difference distribution is calculated to obtain a feature value, so as to reflect an operating status of the unit.

For example, a normal vibration signal input from the reduction gearbox at a 1H test point and historical vibration signal data (a data acquisition manner is acquisition at an interval of 60 seconds, a sampling frequency is 25600 Hz, and a quantity of sampling points is 102400) in a device health status may be collected. Fast Fourier transform is performed on sample data per minute, and amplitude addition and averaging are performed on all frequency-domain sample data according to corresponding frequencies, to obtain an average amplitude spectrum, namely, a frequency-domain baseline space. A to-be-measured frequency-domain signal is input, and subtracted from the baseline space. When a frequency amplitude is less than an amplitude corresponding to the baseline space, a difference is set to zero, and when the frequency amplitude is greater than the amplitude, a sum of differences is obtained. The sum of differences is the baseline space overlimit symptom quantity of the test point.
Step 1304: Determine an operating status of each of the test points based on the fault symptom quantification corresponding to each of the test points.
Step 1305: Determine a fault point and a fault type of the target dynamic equipment according to the operating status of each of the test points in a case of determining, according to the operating status of each of the test points, that the target dynamic equipment has a fault.

The following describes step 1304 and step 1305 together.

The operating status refers to a status corresponding to the test point in an operating process of the target dynamic equipment, and may include a faulty state and a non-faulty state. The non-faulty state is a normal operating state. Further, the faulty state may further be classified into a minor-fault state, a moderate-fault state, and a severe-fault state, fault levels of which are in ascending order. A higher fault level indicates a severer fault.

In an embodiment, the execution entity of this embodiment of the present disclosure may determine, according to one or more fault symptom quantities corresponding to each of the test points in the target dynamic equipment, an operating status corresponding to the test point.

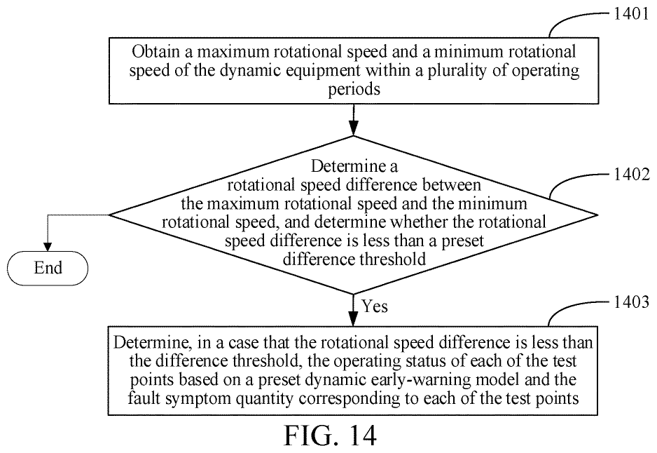

Specifically, how to determine, according to the fault symptom quantification corresponding to each of the test points, an operating status corresponding to each of the test points may be described below by using a procedure shown in FIG. 14. Details are not described herein.

Then, whether the target dynamic equipment has a fault may be determined according to the operating status of each of the test points, and in a case that the target dynamic equipment has a fault, a fault point and a fault type of the target dynamic equipment are determined according to the operating status of each of the test points.

As an example implementation, when it is determined that the operating status of any at least one test point among the plurality of test points on the target dynamic equipment is the faulty state, it may be determined that the target dynamic equipment has a fault.

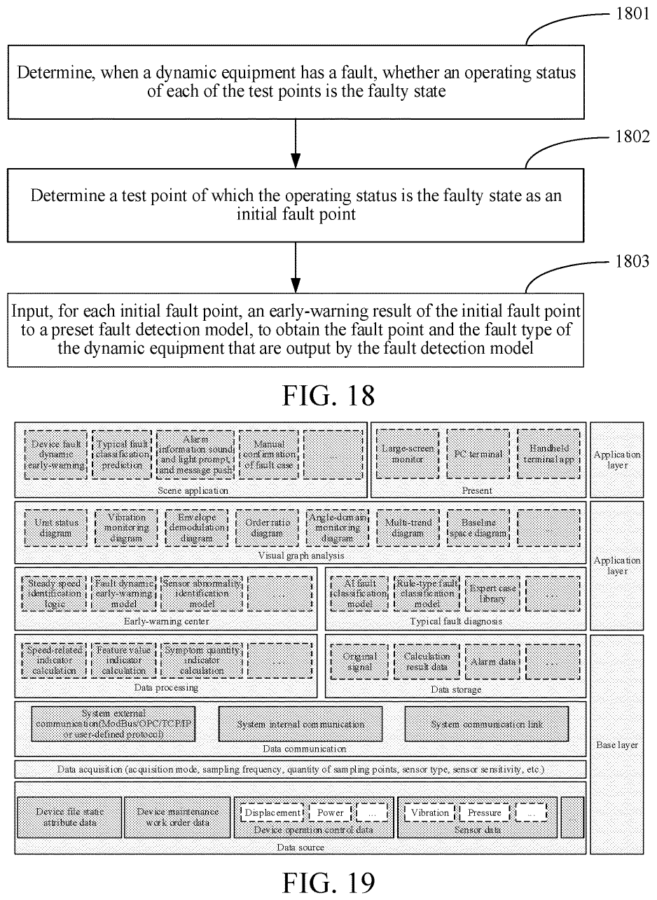

Specifically, how to determine a fault point and a fault type of the target dynamic equipment according to the operating status of each of the test points may be described below by using a procedure shown in FIG. 18. Details are not described herein.

In addition, to enable a user to learn in time that the target dynamic equipment has a fault, when determining that the target dynamic equipment has a fault, the execution entity of this embodiment of the present disclosure may give an alarm in a preset alarm manner, to inform the user that the target dynamic equipment has a fault. The alarm manner may be alarm information sound and light prompt, message push, or the like.

Further, after a fault point and a fault type of the target dynamic equipment are determined, the fault point and the fault type of the target dynamic equipment may be output by using a visual interface, and a technician determines whether the fault point and the fault type of the target dynamic equipment are accurate. After confirmation of the technician is received, the fault point and the fault type are stored to a fault case library.

In addition, to enable the user to further understand an operating condition of the target dynamic equipment, the execution entity of this embodiment of the present disclosure may perform, according to a preset signal processing rule, signal processing and feature transformation on the parameter data of the target dynamic equipment stored in the database (for example, the data source module 1211), to obtain a plurality of types of graph data. The graph data may include, but is not limited to: a unit status diagram, a vibration monitoring diagram, an envelope demodulation diagram, an order ratio diagram, an angle-domain monitoring diagram, a multi-trend diagram, a multi-parameter analysis diagram, and a baseline space diagram.

In addition, to enable the user to learn the fault point and the fault type of the target dynamic equipment in more detail, the execution entity of this embodiment of the present disclosure may generate a three-dimensional image of the target dynamic equipment after determining the fault point and the fault type of the target dynamic equipment, and label the fault point and the fault type of the target dynamic equipment in the three-dimensional image (for example, mark the fault point of the target dynamic equipment in red), to obtain a target three-dimensional image.

Then, the target three-dimensional image may be output, and early-warning is performed in a preset early-warning manner.

In the technical solutions provided in this embodiment of the present disclosure, a plurality of test points of a target dynamic equipment and a parameter retrieval rule of each of the test points are determined. For each of the test points, target parameter data of the test point is matched according to the corresponding parameter retrieval rule. A fault symptom quantification of the test point is determined according to the target parameter data. An operating status of each of the test points is determined based on the fault symptom quantification corresponding to each of the test points. A fault point and a fault type of the target dynamic equipment are determined according to the operating status of each of the test points in a case of determining, according to the operating status of each of the test points, that the target dynamic equipment has a fault. According to this technical solution, the plurality of test points are preset for the target dynamic equipment, and the operating status of each of the test points is determined according to the fault symptom quantification of each of the test points, so as to perform fault detection on the target dynamic equipment. Compared with finding a fault of the target dynamic equipment through expert experience or contrastive analysis, the fault of the dynamic equipment may be detected in real time, and the fault point and the fault type of the dynamic equipment may be determined in a case that an operating fault of the dynamic equipment is detected, thereby finding the operating fault of the dynamic equipment in time, diagnosing the fault, reducing diagnosis and repair costs, and improving user experience.

Refer to FIG. 14, which is a flowchart of an embodiment of another fault monitoring method for dynamic equipment according to an embodiment of the present disclosure. The procedure shown in FIG. 14 describes, based on the procedure shown in FIG. 13, how to specifically determine an operating status corresponding to each of the test points according to a fault symptom quantification corresponding to each of the test points. As shown in FIG. 14, the procedure may include the following steps.
Step 1401: Obtain a maximum rotational speed and a minimum rotational speed of the target dynamic equipment within a plurality of operating periods.

The operating period refers to an operating period of the target dynamic equipment within a preset historical time period. The preset historical time period may be one minute or two minutes before a current moment. This is not limited in this embodiment of the present disclosure.

The maximum rotational speed is a maximum rotational speed at which the target dynamic equipment operates within the preset historical time period.

The minimum rotational speed is a minimum rotational speed at which the target device operates within the preset historical time period.

In an embodiment, an execution entity of this embodiment of the present disclosure may obtain, from a preset database, a maximum rotational speed and a minimum rotational speed of the target dynamic equipment within the plurality of operating periods.

In another embodiment, the execution entity of this embodiment of the present disclosure may obtain, through a visual interface, a maximum rotational speed and a minimum rotational speed, input by a user, of the target dynamic equipment within a plurality of operating periods.
Step 1402: Determine a rotational speed difference between the maximum rotational speed and the minimum rotational speed, and determine whether the rotational speed difference is less than a preset difference threshold. If yes, step 303 is performed. If no, the procedure is ended.
Step 1403: Determine, in a case that the rotational speed difference is less than the difference threshold, the operating status of each of the test points based on a preset dynamic early-warning model and the fault symptom quantification corresponding to each of the test points.

The following describes step 1402 and step 1403 together.

In this embodiment of the present disclosure, when fault monitoring is performed on the target dynamic equipment, whether the target dynamic equipment satisfies a fault monitoring condition may be first determined according to a maximum rotational speed and a minimum rotational speed of the target dynamic equipment. If yes, whether the target dynamic equipment has a fault may continue to be determined. If no, the procedure may be ended.

In an embodiment, after determining a maximum rotational speed and a minimum rotational speed of the target dynamic equipment within a plurality of operation periods, an execution entity of this embodiment of the present disclosure may subtract the minimum rotational speed from the maximum rotational speed, to determine a rotational speed difference corresponding to the target dynamic equipment, and further determine whether the rotational speed difference is less than a preset difference threshold.

In some example implementations, if it is determined that the rotational speed difference is greater than or equal to the difference threshold, it indicates that the current operation of the target dynamic equipment is unstable, and fault monitoring cannot be performed. Therefore, the procedure may be directly ended, and alarm information indicating that the current operation of the target dynamic equipment is unstable is output.

On the contrary, if it is determined that the rotational speed difference is less than the difference threshold, it indicates that the current operation of the target dynamic equipment is stable, and fault monitoring may be performed. Therefore, an operating status of each of the test points may be further determined based on a preset dynamic early-warning model and a fault symptom quantification corresponding to each of the test points. The dynamic early-warning model may be a pre-trained model for predicting an early-warning result of each fault symptom quantification.

As an example implementation, the execution entity of this embodiment of the present disclosure may first obtain historical operating data of the target dynamic equipment within a preset historical time period and a configuration parameter of the preset dynamic early-warning model. The preset historical time period may be one or two days or a week in the past. This is not limited in this embodiment of the present disclosure. The configuration parameter of the dynamic early-warning model may be a parameter involved in the dynamic early-warning model, for example, a multi-level threshold of each fault symptom quantification.

Then, the historical operating data, the fault symptom quantification corresponding to each of the test points, and the configuration parameter may be input to the dynamic early-warning model, to obtain an early-warning result corresponding to each fault symptom quantification that is output by the dynamic early-warning model, for example, 1 (normal), 2 (low fault risk), 3 (moderate fault risk), and 4 (high fault risk).

Finally, an operating status of each of the test points may be determined based on the early-warning result corresponding to each fault symptom quantification, where the operating status may include a faulty state and a non-faulty state.

In an embodiment, the fault symptom quantification may include a sensor abnormality symptom quantity, which may be configured for representing whether a sensor that acquires the parameter data of the target dynamic equipment is abnormal. Based on this, when determining the operating status of each of the test points based on the early-warning result corresponding to each fault symptom quantification, the execution entity of this embodiment of the present disclosure may first determine whether the early-warning result corresponding to the sensor abnormality symptom quantity is fault early-warning.

In some example implementations, if it is determined that the early-warning result corresponding to the sensor abnormality symptom quantity is fault early-warning, it indicates that the sensor for acquiring the parameter data of the target dynamic equipment is abnormal in this case, and the parameter data used as a basis for fault monitoring of the target dynamic equipment may have an error. Therefore, the current fault monitoring and determining may be directly ended, and alarm information indicating sensor abnormality is output.

On the contrary, if it is determined that the early-warning result corresponding to the sensor abnormality symptom quantity is non-fault early-warning, sensor signal data currently acquired by the sensor is further obtained, and the sensor signal data is input to a preset sensor fault identification model, to obtain a sensor abnormality identification result output by the sensor fault identification model.

The sensor fault identification model may be a neural network model constructed based on historical normal device data and sensor fault sample data, and sensor fault identification is implemented through model training. The neural network model may be an unsupervised learning model, a supervised classification learning model, or the like. The network structure may be, but is not limited to, an autoencoder neural network structure, a CNN structure, a fully-connected neural network model structure, or another network structure obtained by combining the foregoing neural network model structures.

Further, if the sensor abnormality identification result represents that an anomaly occurs in the sensor, it indicates that the parameter data acquired by the target dynamic equipment using the sensor in this case is inaccurate. Therefore, it may be determined that the operating status of each of the test points is the non-faulty state.

In some example implementations, if the sensor abnormality identification result represents that no anomaly occurs in the sensor, it indicates that the sensor operates normally in this case. Therefore, the operating status of the test point may be determined according to an early-warning result level of each fault symptom quantification corresponding to each of the test points.

As an example implementation, each of the test points on the target dynamic equipment may include one or more fault symptom quantities, and an early-warning result of each fault symptom quantification may include a plurality of levels, for example, 1 (normal), 2 (low fault risk), 3 (moderate fault risk), and 4 (high fault risk). Therefore, an early-warning result level of each symptom quantity corresponding to each of the test points may be determined, and a fault status corresponding to the early-warning result having the highest early-warning result level is determined as an operating status of the corresponding test point.

For example, it is assumed that a test point 1 includes three fault symptom quantities, and corresponding early-warning results are respectively 1 (normal), 2 (low fault risk), and 4 (high fault risk). It can be seen that the early-warning result having the highest early-warning result level is 4 (high fault risk). It is further assumed that a fault status corresponding to 4 (high fault risk) is high-risk fault operation, and an operating status corresponding to the test point 1 is high-risk fault operation.

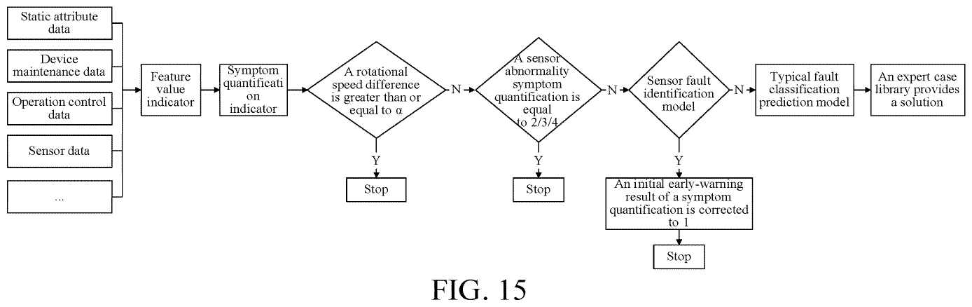

The following describes how to specifically determine the operating status corresponding to each of the test points according to the fault symptom quantification corresponding to each of the test points in this embodiment of the present disclosure by using an example in which fault early-warning of a fault identification symptom quantity (referred to as ae symptom quantity below) of a test point at an input side of a fluid end of a plunger pump is used. Refer to FIG. 15, which is a flowchart of an embodiment of still another fault monitoring method for dynamic equipment according to an embodiment of the present disclosure. As shown in FIG. 15, the procedure may include:

First, a motor speed at a current moment and a rotational speed difference (namely, a difference between a maximum rotational speed and a minimum rotational speed of a device in a plurality of operating periods within one minute) are input, and it is determined whether the rotational speed difference is greater than a rotational speed difference threshold a. Early-warning logic is disabled if the rotational speed difference is greater than or equal to a. Otherwise, the ae symptom quantity of the current moment and historical data of the previous n moments are input to a dynamic early-warning model, and an initial early-warning result result_label is output.

Then, it is determined whether a sensor abnormal symptom quantity in result_label is a 2/3/4 label (to be specific, the early-warning result is 2 (low fault risk), 3 (moderate fault risk), or 4 (high fault risk)). If yes, the early-warning logic is disabled. Otherwise, original signal data of the current moment is input to a sensor fault identification model.

Then, the sensor fault identification model outputs a sensor fault status label, and state levels are classified into 1 (normal), 2 (low fault risk), 3 (moderate fault risk), and 4 (high fault risk). If the label is 2/3/4, the initial early-warning result of the symptom quantity in which the label is 2/3/4 in result_label is corrected to 1. Otherwise, the initial early-warning result is directly output as a final early-warning result.

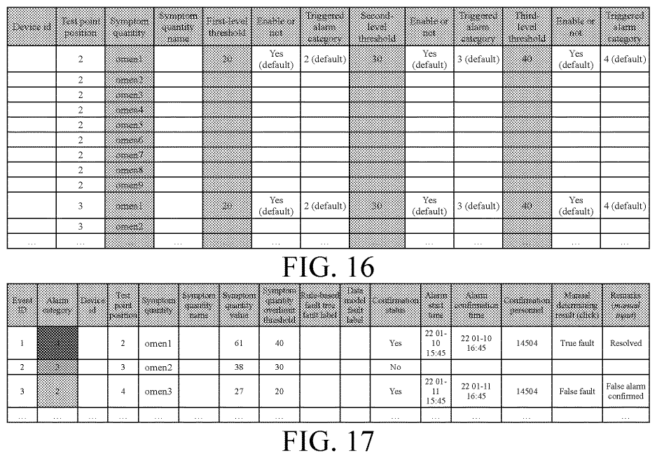

An early-warning threshold of the dynamic fault early-warning model relates to a multi-level early-warning threshold configuration of all symptom quantities. A front-end interface may autonomously perform the foregoing threshold configuration function interface, and a front-end manual configuration background synchronously updates a threshold configuration table. The threshold configuration data function interface is shown in FIG. 16. Refer to FIG. 16, which is a schematic diagram of a threshold configuration data function interface according to an embodiment of the present disclosure. As shown in FIG. 16, the threshold configuration data function interface may include: a device id, a test point position, a symptom quantity, a symptom quantity name, a first-level threshold, enable or not, a triggered alarm category, a second-level threshold, enable or not, a triggered alarm category, a third-level threshold, enable or not, and a first-level triggered alarm category.

In addition, the execution entity of this embodiment of the present disclosure may further include a historical alarm log, which is an important tool. All alarms that have occurred may be clearly viewed, and whether these alarms have been confirmed may be clearly viewed, so that users may be ensured that they master all the alarms. A historical alarm log data function interface is shown in FIG. 17. FIG. 17 is a schematic diagram of a historical alarm log data function interface according to an embodiment of the present disclosure. As shown in FIG. 17, the historical alarm log data function interface may include: parameters such as an event ID, an alarm category, a device id, a test point position, a symptom quantity, a symptom quantity name, a symptom quantity value, a symptom quantity overlimit threshold, a rule-based fault tree fault label, a data model fault label, a confirmation status, an alarm start time, an alarm confirmation time, confirmation personnel, a manual determination result, and remarks.

According to the technical solution provided in this embodiment of the present disclosure, a maximum rotational speed and a minimum rotational speed of a target dynamic equipment within a plurality of operating periods are obtained, a rotational speed difference between the maximum rotational speed and the minimum rotational speed is determined, whether the rotational speed difference is less than a preset difference threshold is determined. If yes, an operating status of each of the test points is determined based on a preset dynamic early-warning model and a fault symptom quantification corresponding to each of the test points in a case that the rotational speed difference is less than the difference threshold. If no, the procedure is ended. According to this technical solution, when it is determined that the target dynamic equipment operates stably, the operating status of the test point is determined based on the dynamic early-warning model trained in advance and the fault symptom quantification corresponding to each of the test points. In this way, the operating status of each of the test points may be determined more accurately by training the dynamic early-warning model, so as to more accurately determine the operating status of each of the test points on the target dynamic equipment, thereby finding an operating fault of the dynamic equipment in time, diagnosing the fault, reducing diagnosis and repair costs, and improving user experience.

Refer to FIG. 18, which is a flowchart of an embodiment of yet another fault monitoring method for dynamic equipment according to an embodiment of the present disclosure. A procedure shown in FIG. 18 further describes, based on the procedure shown in FIG. 14, how to specifically determine a fault point and a fault type of the target dynamic equipment according to the operating status of each of the test points. As shown in FIG. 18, the procedure may include the following steps.
Step 1801: Determine, in a case that a target dynamic equipment has a fault, whether an operating status of each of the test points is the faulty state.
Step 1802: Determine a test point of which the operating status is the faulty state as an initial fault point.

The following describes step 1801 and step 1802 together.

It can be seen from the procedure shown in FIG. 14 that, the early-warning result of the fault symptom quantification corresponding to each of the test points on the target dynamic equipment may include: 1 (normal), 2 (low fault risk), 3 (moderate fault risk), and 4 (high fault risk). Based on this, it may be determined that the operating status of each of the test points is the faulty state or the non-faulty state. The faulty state may be further divided into low-risk fault operation, moderate-risk fault operation, and high-risk fault operation.

Based on this, when an execution entity of this embodiment of the present disclosure determines that the operating status of any of the test points on the target dynamic equipment is the faulty state, it is determined that the target dynamic equipment has a fault.

Further, when it is determined that the target dynamic equipment has a fault, whether the operating status of each of the test points is the faulty state may be determined, and a test point of which the operating status is the faulty state is determined as an initial fault point.
Step 1803: Input, for each initial fault point, an early-warning result of the initial fault point to a preset fault detection model, to obtain the fault point and the fault type of the target dynamic equipment that are output by the fault detection model.

The fault detection model may be a pre-trained model for detecting the fault point and the fault type of the target dynamic equipment.

In this embodiment of the present disclosure, the early-warning result corresponding to the initial fault point may be input to the fault detection model, so as to obtain the fault point and the fault type of the target dynamic equipment that are output by the fault detection model.

Further, the fault detection model may include a typical fault classification model and a fault analysis model. The typical fault classification model may be configured to determine whether the fault type of the target dynamic equipment is a typical fault. The fault analysis model may be configured to analyze a fault point and a basic fault type of the target dynamic equipment.

Based on this, when the fault point and the fault type of the target dynamic equipment are determined by using the fault detection model, the early-warning result corresponding to the initial fault point may be input to the typical fault classification model and the fault analysis model respectively, to obtain a typical fault classification result output by the typical fault classification model and a fault analysis result output by the fault analysis model.

Then, weighted summation may be performed on the typical fault classification result and the fault analysis result, to obtain the fault point and the fault type corresponding to the target dynamic equipment.

Further, to provide a more accurate fault type and a corresponding solution for a user to improve user experience, the execution entity of this embodiment of the present disclosure may determine whether the fault type is a typical fault type.

In some example implementations, in a case that the fault type is the typical fault type, the fault type may be matched against a preset typical fault case library, to obtain a target solution corresponding to the fault type, where the typical fault case library may be configured for storing typical faults and a solution corresponding to each of the typical faults.

Then, the target solution may be output by using a visual interface.

In addition, the fault type and the target solution are manually confirmed, and service personnel or diagnosis personnel may manually confirm a current fault diagnosis result on a front-end operation interface. Subsequent fault case events and solutions are manually confirmed, and automatically transferred into the fault case library.

For example, in the following, in a rule-type fault diagnosis model of a plunger pump, a misalignment fault expert determining rule of a coupling is shown in Table 1:

TABLE 1

| | | | Weight |
|---|---|---|---|
| No. | Feature indicator | Symptom quantity | value |
| 1 | Pass-frequency | s1: A second harmonic amplitude | 0.3 |
| | effective value | occupies more than 75% | |
| | | of a pass frequency value | |
| 2 | First harmonic | s2: A first harmonic amplitude | 0.4 |
| | amplitude | increases as a load increases | |
| 3 | Second harmonic | s3: A second harmonic amplitude | 0.4 |
| | amplitude | increases as a load increases | |

Assuming that a confidence level of the rule is 95%, a fault probability of “bad alignment of the coupling” is equal to 95%*(0.3s1+0.4s2+0.4s3).

According to the technical solution provided in this embodiment of the present disclosure, whether an operating status of each of the test points is the faulty state is determined when it is determined that the target dynamic equipment has a fault, and a test point of which the operating status is the faulty state is determined as an initial fault point. For each initial fault point, an early-warning result of the initial fault point is input to a preset fault detection model, to obtain a fault point and a fault type of the target dynamic equipment that are output by the fault detection model. In this technical solution, a fault point and a fault type of the target dynamic equipment may be accurately predicted by using the preset fault detection model and according to the operating status of each of the test points, so as to more accurately determine the fault point and the fault type of the target dynamic equipment, thereby finding an operating fault of the dynamic equipment in time, diagnosing the fault, reducing diagnosis and repair costs, and improving user experience.

Refer to FIG. 19, which is a schematic structural diagram of another fault monitoring system for dynamic equipment according to an embodiment of the present disclosure. As shown in FIG. 19, the fault monitoring system for dynamic equipment may include: a data source, a data acquisition module, a data processing module, an early-warning center module, a data storage module, a data communication module, a graph analysis module, and a fault diagnosis module.

The data source may be configured to store, but is not limited to, the following four types of parameter data: device file static attribute data, device maintenance work order data, device operation control data, and sensor data.

The data acquisition module may acquire analog signals of various sensors, and convert the analog signals into digital signals by conversion. The acquisition module may set an acquisition mode, a sampling frequency, a quantity of sampling points, a sensor type, sensor sensitivity, and the like, support multi-channel synchronous acquisition, support interval acquisition, and trigger acquisition by using a rotational speed or feature indicator.

The data processing module mainly includes rotational speed calculation, feature value calculation, and symptom quantity calculation. The feature value refers to indicator data that is calculated or extracted by performing a series of numerical transformations on original signals such as static attribute data, device maintenance data, operating control data, and sensor data and that can reflect a main distribution feature of data. The symptom quantity refers to a fault symptom variable or factor that is generated by performing data combination based on the feature value or original data and that can have a strong association relationship with a fault of the device.

The early-warning center module, also referred to as an alarm module, implements main functions of fault dynamic early-warning, including: a stable rotational speed work condition identification function, a device dynamic early-warning function, and a sensor abnormality identification function. Input data of the early-warning center is a to-be-measured symptom quantity, a motor speed difference, and a dynamic early-warning model configuration parameter after data processing. Output data is a current early-warning status of each symptom quantity, and state levels are classified into 1 (normal), 2 (low fault risk), 3 (moderate fault risk), and 4 (high fault risk). The early-warning center implements dynamic multi-level fault early-warning by using a series of data flowing, function item invoking, and control logic, and can prevent situations such as outlier false alarms and repeated alarms of a same alarm event from occurring. In addition, the front-end interface provides a custom configuration function for a threshold of a dynamic early-warning function and an early-warning model parameter, so that a user can customize an early-warning model according to an actual service requirement.

Alarm information may be displayed on a large-screen monitor, a PC terminal, a handheld terminal APP, and the like. An acoustic and light alarm prompt is sent, and the alarm information is pushed by using a short message, a message prompt, or an email. In addition, for historical alarm information, a system provides query, storage, and analysis functions of a historical alarm log.

The typical fault diagnosis module mainly implements, based on fault early-warning, fault classification prediction and fault location, and provides solution recommendation for an expert case library. The fault diagnosis module includes AI fault diagnosis and rule-type fault diagnosis. The AI fault diagnosis mainly includes: constructing a neural network model based on historical device normality and typical fault sample data of different levels, and obtaining a typical fault AI fault diagnosis model through model training, to implement typical fault classification prediction. The rule-type fault diagnosis includes: by relying on various structured and stored expert experience rules, performing fault location and classification identification of early-warning data. The expert case library includes structured storage results of various typical fault case events and expert recommendation solutions.

Specifically, an alarm result of the early-warning center is input to the fault diagnosis module for further fault location and classification. If an early-warning result of a test point is 2/3/4, an AI fault diagnosis model and a rule-type fault diagnosis model of the test point are invoked, weighted fusion is performed on prediction results of the two models, and a prediction fault type of the test point is output. Meanwhile, the fault expert recommendation solution is output according to association of the fault type with the fault case library. The AI fault diagnosis model is a pretraining model. For various device typical faults, the AI fault diagnosis model includes, but is not limited to, a gas valve leakage fault classification prediction model, a bearing fault classification prediction model, and a gear fault classification prediction model. The rule-type model is generated by performing structured processing and storage on expert determining rules of various historical fault events.

Meanwhile, a prediction result of the fault diagnosis module provides a manual confirmation interface, and service personnel or diagnosis personnel may manually confirm a current fault diagnosis result on a front-end operation interface. Subsequent fault case events and solutions are manually confirmed, and automatically transferred into the fault case library.

The storage module may store data of the acquisition module, the calculation module, and the alarm module, satisfying a data capacity of at least 6 months or another period. For a sensor acquisition data thinning policy: The alarm data is permanently stored. Normal data is significantly thinned according to a time period such as year, month, day, or hour, to ensure that there is data in each time period. Longer time indicates more thinned data.

For example, storage of alarm data of a fault dynamic early-warning system of a plunger pump includes: all symptom quantity original data and all symptom quantity status label data.

The communication module may be divided into three parts: system internal communication, system external communication, and a system communication link. The system internal communication is mainly implemented by using a communication method such as UDP/HTTP. The system external communication uses a standard communication protocol (ModBus/OPC/TCP/IP . . . ) or a user-defined protocol. The internal and external communication entirely includes a hardware layer protocol, a network layer transport protocol, an application layer protocol, and the like. Data transmission and exchange between different information systems (a PLC, an operating data acquisition system, and the like) and between different units and modules in the current system are completed. In addition, the system data communication link includes a sensor, a data acquisition device, an edge industrial personal computer, an industrial gateway, and a remote server.

The graph analysis module may be configured to perform signal processing and feature transformation on an original signal, to obtain professional graph data, to assist an engineer in performing fault diagnosis on a unit. The graph analysis module mainly includes the following functions:

A unit status diagram displays real-time operating statuses of reciprocating pumps and subcomponents, where the statuses include: normal, early-warning, alarm, and high-alarm.

A vibration monitoring diagram displays trends, waveforms, and spectra of real-time and historical feature values of vibration test points.

An envelope demodulation diagram amplifies a high-frequency resonance response wave generated by a fault impact, changes into a low-frequency waveform having fault feature information by using an envelope detection method, and then finds a fault feature frequency by using a spectrum analysis method.

In some example implementations, algorithm steps thereof may be: first, filtering out a target frequency component by using a filter characteristic of a band-pass filter; second, extracting a modulation signal from signals by Hilbert transformation, and analyzing a change of the modulation signal; and finally, separating a low-frequency signal component from a vibration signal by Fourier transform.

An order ratio diagram converts, with reference to key phase data, a time-domain waveform sampled at equal time into a time-domain waveform sampled at equal angles, and then performs Fourier transform and another transform.

An angle-domain monitoring diagram displays an entire periodic signal, including an angle-domain waveform diagram, an angle-domain envelope diagram, and an angle-domain histogram, of each reciprocating test point.

In some example implementations, algorithm steps thereof may be: first, capturing key phase data and vibration data or other parameter data of an entire period; second, interpolating the key phase data to obtain time corresponding to an angle of 1° or another equal interval, namely, a set {angle, t}; then, interpolating the vibration data, where an interpolation point is angle, to obtain an amplitude corresponding to angle, namely, a set {angle, amp}, that is, an angle-domain waveform; performing hilbert transformation on the angle-domain waveform to obtain an angle-domain envelope diagram; and performing piecewise segmentation calculation on the angle-domain waveform, to obtain an angle-domain histogram.

A multi-trend diagram displays real-time and historical feature value trends of status parameters such as speed, vibration, pressure, and temperature.

A multi-parameter analysis diagram synchronously analyzes an entire-period vibration waveform, an intracavity pressure waveform, a crosshead temperature, and the like that have a same horizontal coordinate.

A baseline space diagram displays a comparison result and difference with the baseline space.

According to the fault monitoring system for dynamic equipment provided in this embodiment of the present disclosure, real-time operating status monitoring and fault early-warning of components of dynamic equipment may be implemented, which includes different types of device fault symptom quantities, implementing a device fault response. An early-warning center invokes a dynamic early-warning model and a sensor fault identification model by using logic of the early-warning center, implementing device fault early-warning and sensor fault determining. A typical fault classification prediction result and a fault solution may be output, and a fault case may be stored in a structured manner. Further, a visual interface may be implemented to identify and trace a whole process fault event from configuration of an early-warning model, early-warning, and alarm, to manual confirmation and graph analysis, thereby greatly reducing a professional threshold of users, and improving production operation efficiency.

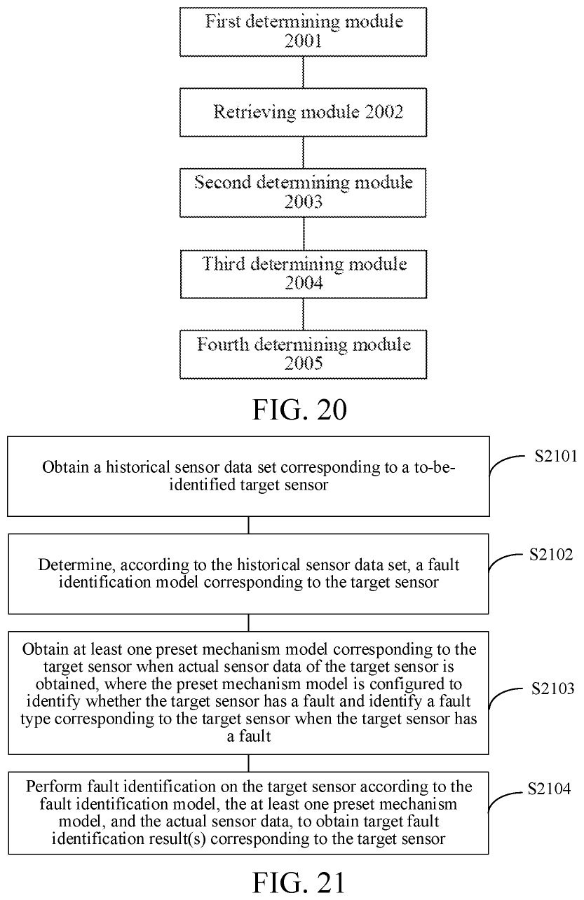

Refer to FIG. 20, which is a block diagram of an embodiment of a fault monitoring apparatus for dynamic equipment according to an embodiment of the present disclosure. The apparatus shown in FIG. 20 may be applied to the fault monitoring system for dynamic equipment shown in FIG. 12. As shown in FIG. 20, the apparatus may include:
a first determining module 2001, configured to determine a plurality of test points of a target dynamic equipment and a parameter retrieval rule of each of the test points;
a retrieving module 2002, configured to match, for each of the test points, target parameter data of the test point according to the corresponding parameter retrieval rule;
a second determining module 2003, configured to determine a fault symptom quantification of the test point according to the target parameter data;
a third determining module 2004, configured to determine an operating status of each of the test points based on the fault symptom quantification corresponding to each of the test points; and
a fourth determining module 2005, configured to determine a fault point and a fault type of the target dynamic equipment according to the operating status of each of the test points in a case of determining, according to the operating status of each of the test points, that the target dynamic equipment has a fault.

In the related art, to ensure safe operation of a mechanical device, a large number of different sensors are generally disposed in the mechanical device, so that during operation of the mechanical device, related data is acquired by using the disposed sensors, to analyze an operating status of the mechanical device according to the acquired data, thereby ensuring safe operation of the mechanical device. It can be seen that the sensors disposed in the mechanical device are crucial to ensure safe operation of the mechanical device. However, the sensors may be affected by various factors in a working process, causing a sensor fault. The sensor fault may affect safe operation of the mechanical device. Currently, to avoid impact of the sensor fault on safe operation of the mechanical device, the sensors in the mechanical device are usually regularly identified manually, to replace the faulty sensor when the faulty sensor is identified. However, because there are many sensors in the mechanical device, identifying the sensor fault in the foregoing manner not only wastes a large amount of manpower and material power, but also affects operation of the mechanical device, thereby affecting production efficiency.

In view of this, the present disclosure provides a sensor fault identification method, so as to resolve the technical problem that identifying a sensor fault in the foregoing manner not only wastes a large amount of manpower and material power, but also affects operation of the mechanical device, thereby affecting production efficiency.

Refer to FIG. 21. FIG. 21 is a schematic flowchart of a sensor fault identification method according to an embodiment of the present disclosure. A sensor fault identification method provided in an embodiment of the present disclosure includes the following steps:
S2101: Obtain a historical sensor data set corresponding to a to-be-identified target sensor.
S2102: Determine, according to the historical sensor data set, a fault identification model corresponding to the target sensor.

For step S2101 and step S2102, the target sensor is mounted in a mechanical device. A type of the target sensor may be selected according to an actual requirement. The type of the target sensor is not specifically limited in this embodiment. For example, the target sensor may be a vibration sensor, a temperature sensor, or a pressure sensor. The historical sensor data set includes a plurality of pieces of historical sensor data. The historical sensor data is sensor data before fault identification is performed on the target sensor. The historical sensor data is specifically historical sensor backhaul data. The historical sensor data set includes a plurality of pieces of normal historical sensor data. The historical sensor data set further includes a plurality of historical sensors of different fault types. The historical fault data set may be obtained from a log recorded during operation of the mechanical device.

It should be noted that target sensors of a same type are placed at different positions in the mechanical device. When the fault identification model is determined by using the historical sensor data set, to ensure accuracy of the obtained fault identification model, historical sensor data of all the target sensors of the same type in the mechanical device may be obtained, to obtain the historical sensor data set after filtering all the obtained historical sensor data.

Specifically, to identify a fault of the sensor, a preset classification model may be pre-selected, to train the preset classification model after the historical sensor data set is obtained, to obtain a final fault identification model. Therefore, when fault identification is performed on the target sensor by using the fault identification model, whether the target sensor is faulty and a fault type corresponding to the target sensor can be identified. The determining, according to the historical sensor data set, the fault identification model corresponding to the target sensor specifically includes:
performing, for each piece of historical sensor data in the historical sensor data set, fault classification labeling on the historical sensor data, to obtain training sample data corresponding to the historical sensor data; and
training a preset classification model according to the training sample data corresponding to all the historical sensor data in the historical sensor data set, to obtain the fault identification model corresponding to the target sensor.

In this embodiment, after a historical sensor data set corresponding to a to-be-identified target sensor is obtained, a fault type of each historical sensor in the historical sensor data set is labeled, to distinguish whether the historical sensor data is normal data or fault data, and label the fault type of the historical sensor data when the historical sensor data is the fault data. For example, the fault type may be an electromagnetic interference fault, a short-circuit fault, or a disconnection fault. After fault classification and labeling are performed on each piece of historical sensor data in the historical sensor data set, training sample data corresponding to each piece of historical sensor data in the historical sensor data set can be obtained. Further, a training sample data set corresponding to the historical sensor data set can be obtained. All training sample data in the training sample data set is divided according to a preset ratio, to obtain a training set, a verification set, and a test set. The fault identification model corresponding to the target sensor may be obtained by training the preset classification model according to the training set, the verification set, and the test set. The preset ratio may be set according to an actual requirement. A specific value of the preset ratio is not specifically limited in this embodiment. For example, the preset ratio may be 20:3:2. The preset classification model may be selected according to an actual requirement. A specific form of the preset classification model is not limited in this embodiment. For example, the preset classification model may be a CNN model.
S2103: Obtain at least one preset mechanism model corresponding to the target sensor when actual sensor data of the target sensor is obtained, where the preset mechanism model is configured to identify whether the target sensor has a fault and identify a fault type corresponding to the target sensor when the target sensor has a fault.

In this embodiment, the actual sensor data of the target sensor is actually actual backhaul data of the target sensor in a working process. The fault type of the target sensor mainly includes disconnection of the target sensor, reverse power supply of the target sensor, short-circuit of the target sensor, overload of the target sensor, and the like. For each fault of the target sensor, a preset mechanism model corresponding to the target sensor may be disposed in advance, to identify a fault of the target sensor by using the preset mechanism model in the working process of the target sensor, so as to determine whether the target sensor has a fault and a fault type of the target sensor corresponding to the target sensor when the target sensor has a fault.

Specifically, the at least one preset mechanism model includes a bias voltage model, an output signal model, and a spectrum model. The actual sensor data includes an actual bias voltage, an actual output signal value, and an actual spectrum. Each preset mechanism model stores a preset threshold and a correspondence between a comparison result and a fault identification result. The comparison result is a result of comparison between the actual sensor data and the preset threshold. To be specific, for the bias voltage model, the bias voltage model stores a corresponding preset threshold and a correspondence between a comparison result and a fault identification result. For the output signal model, the output signal model stores a corresponding preset threshold and a correspondence between a comparison result and a fault identification result. For the spectrum model, the spectrum model stores a corresponding preset threshold and a correspondence between a comparison result and a fault identification result. It should be noted that the preset thresholds in the bias voltage model, the output signal model, and the spectrum model may be set according to an actual requirement. Specific values of the preset thresholds are not specifically limited in this embodiment.

In the foregoing, after the at least one preset mechanism model and the actual sensor data of the target sensor are obtained, fault identification of the target sensor may be implemented according to the preset threshold and the correspondence between the comparison result and a fault identification result stored in each preset mechanism model.
S2104: Perform fault identification on the target sensor according to the fault identification model, the at least one preset mechanism model, and the actual sensor data, to obtain target fault identification result(s) corresponding to the target sensor.

In this embodiment, in the working process of the target sensor, both the fault identification model and the at least one preset mechanism model may implement fault identification of the target sensor. With reference to the fault identification model and the at least one preset mechanism model, fault identification of the target sensor can be finally implemented, avoiding a disadvantage that fault identification of the target sensor is periodically performed manually.

According to the sensor fault identification method provided in this embodiment, based on determining a fault identification model corresponding to a target sensor and obtaining a preset mechanism model that is disposed in advance and corresponds to the target sensor, fault identification is performed on the target sensor with reference to the fault identification model and the preset mechanism model in a working process of the target sensor, to obtain final target fault identification result(s), thereby implementing fault identification of the target sensor, avoiding disadvantages of periodically performing fault identification on the target sensor manually, reducing expenditure of manpower and material power, and improving production efficiency of a mechanical device provided with the target sensor.

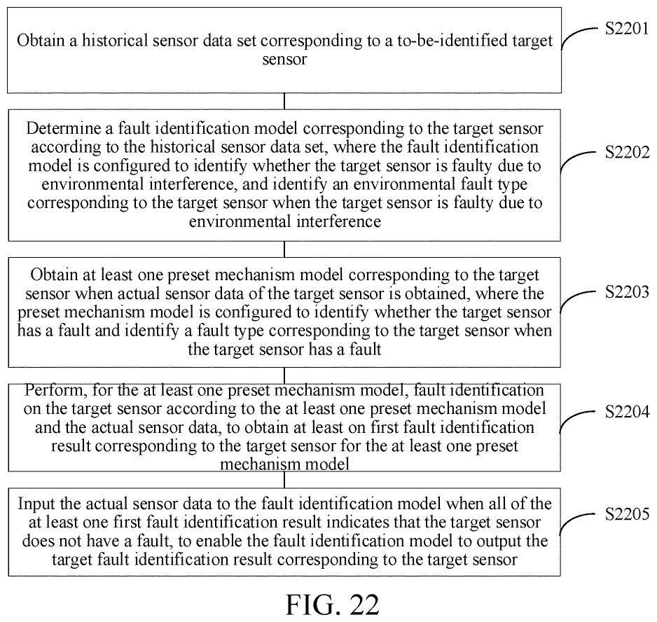

Refer to FIG. 22. FIG. 22 is a schematic flowchart of another sensor fault identification method according to an embodiment of the present disclosure. A sensor fault identification method provided in an embodiment of the present disclosure includes the following steps:
S2201: Obtain a historical sensor data set corresponding to a to-be-identified target sensor.

In this embodiment, step S2201 is the same as step S2101. For details, refer to the foregoing step S2101. Details are not described herein again in this embodiment.
S2202: Determine a fault identification model corresponding to the target sensor according to the historical sensor data set, where the fault identification model is configured to identify whether the target sensor is faulty due to environmental interference, and identify an environmental fault type corresponding to the target sensor when the target sensor is faulty due to environmental interference.

In this embodiment, the fault identification model is only configured to identify whether the target sensor is faulty due to environmental interference and identify an environmental fault type corresponding to the target sensor when the target sensor is faulty due to environmental interference. Therefore, when fault identification is performed on the target sensor, if it is identified, by using the at least one preset mechanism model, that the target sensor has a fault, the fault identification model does not need to operate to further perform fault identification on the target sensor, so as to reduce resource waste. The environmental fault type includes electromagnetic interference and the like.
S2203: Obtain at least one preset mechanism model corresponding to the target sensor when actual sensor data of the target sensor is obtained, where the preset mechanism model is configured to identify whether the target sensor has a fault and identify a fault type corresponding to the target sensor when the target sensor has a fault.

In this embodiment, step S2203 is the same as step S2103. For details, refer to the foregoing step S2103. Details are not described herein again in this embodiment.
S2204: Perform, for each preset mechanism model of the at least one preset mechanism model, fault identification on the target sensor according to the preset mechanism model and the actual sensor data, to obtain first fault identification result(s) corresponding to the target sensor.
S2205: Input the actual sensor data to the fault identification model when all of the first fault identification results are that the target sensor does not have a fault, to enable the fault identification model to output the target fault identification result(s) corresponding to the target sensor.

For the foregoing steps S2204 and S2205, each preset mechanism model stores only the preset threshold, the comparison result, and the fault identification result, and the preset mechanism model can identify whether the target sensor has a fault and the fault type corresponding to the target sensor when the target sensor has a fault. Therefore, fault identification of the target sensor may be implemented by using only a few hardware resources. Therefore, when fault identification is performed on the target sensor, fault identification may be first performed on the target sensor by using the at least one preset mechanism model disposed in advance, so that when it is determined that the target sensor has a fault and the fault type corresponding to the target sensor is determined, fault identification does not need to be further performed on the target sensor by using the fault identification model. To be specific, when a first fault identification result among all the first fault identification results indicates a fault of the target sensor and a fault type corresponding to the target sensor when the target sensor has a fault, the fault of the target sensor and the fault type corresponding to the target sensor when the target sensor has a fault are used as a target fault identification result. Actual sensor data does not need to be input into the fault identification model to further perform fault identification on the target sensor. Only when it is identified, by using the preset mechanism model, that the target sensor does not have a fault (to be specific, all first fault identification results indicate that the target sensor does not have a fault), the target sensor is further identified by using the fault identification model, to identify whether the target sensor is faulty due to environmental interference and identify an environmental fault type corresponding to the target sensor when the target sensor is faulty due to environmental interference. Because the fault identification model needs to be supported by a plurality of hardware resources during operation, unnecessary resource waste can be reduced in the foregoing manner.

In this embodiment, the preset mechanism model is consistent with the foregoing. The preset mechanism model is not described in detail herein in this embodiment. The performing fault identification on the target sensor according to the preset mechanism model and the actual sensor data, to obtain the first fault identification result(s) corresponding to the target sensor includes:
comparing, when the preset mechanism model is the bias voltage model, the actual bias voltage with the preset threshold in the bias voltage model, to obtain a first comparison result; and determining first fault identification result(s) corresponding to the first comparison result according to the correspondence between the comparison result and a fault identification result in the bias voltage model;
comparing, when the preset mechanism model is the output signal model, the actual output signal value with the preset threshold in the output signal model, to obtain a second comparison result; and determining first fault identification result(s) corresponding to the second comparison result according to the correspondence between the comparison result and a fault identification result in the output signal model; and
determining, when the preset mechanism model is the spectrum model, a ski slope factor according to the actual spectrum; comparing the ski slope factor with the preset threshold in the spectrum model, to obtain a third comparison result; and determining first fault identification result(s) corresponding to the third comparison result according to the correspondence between the comparison result and a fault identification result in the spectrum model.

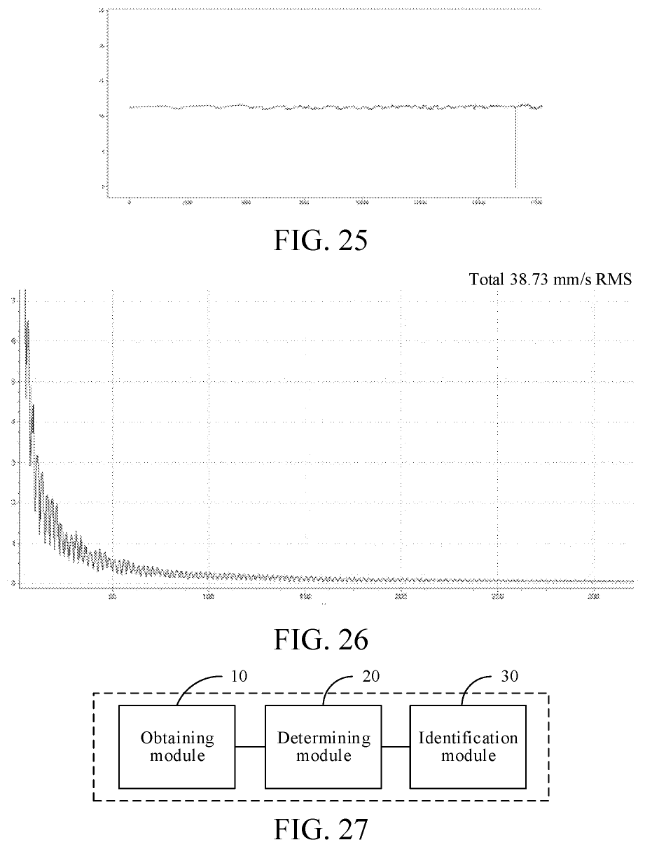

Specifically, there may be a plurality of preset thresholds stored in the bias voltage model. For the bias voltage model, the bias voltage model further stores a correspondence, corresponding to each preset threshold, between a comparison result and a fault identification result. For example, when the preset threshold stored in the bias voltage model includes a first preset threshold and a second preset threshold, the bias voltage model stores a correspondence, corresponding to the first preset threshold, between a comparison result and a fault identification result, and the bias voltage model further stores a correspondence, corresponding to the second preset threshold, between a comparison result and a fault identification result. Because a bias voltage is a common characteristic of the sensor, the bias voltage in the sensor is generally set to a preset level. Using an acceleration sensor as an example, the bias voltage is usually set to 12 V. Regardless of how a supply voltage changes, due to an internal feature of the sensor, the bias voltage should fluctuate within a specified range all the time. If the bias voltage exceeds the specified range, for example, referring to FIG. 24, the bias voltage is equal to the supply voltage, it indicates that the sensor is disconnected or supplies power reversely, and a connector or a cable needs to be checked. For another example, referring to FIG. 25, when the bias voltage is zero volt, it is usually determined that an internal line of the sensor is short-circuited. Therefore, according to the internal feature of the bias voltage of the sensor, an actual bias voltage of the target sensor can be determined according to the preset mechanism model corresponding to the preset bias voltage, to implement fault identification of the target sensor. It should be noted that the preset threshold and the correspondence between the comparison result and the fault identification result, which are stored in the preset mechanism model corresponding to the bias voltage, may be set according to an actual requirement, and are not specifically limited in this embodiment. When an actual bias voltage is determined by using the preset threshold stored in the preset mechanism model corresponding to the bias voltage, to implement fault identification of the target sensor, an obtained fault identification result not only includes whether the target sensor has a fault and a fault type (namely, a disconnection fault or a short-circuit fault) corresponding to the target sensor when the target sensor has a fault.

The output signal usually includes an output voltage signal and an output current signal. A specific form of the output signal may be set according to an actual requirement, and is not specifically limited in this embodiment. The output signal model may alternatively store a plurality of preset thresholds. For the output signal model, the output signal model further stores a correspondence, corresponding to each preset threshold, between a comparison result and a fault identification result. For example, when the preset threshold stored in the output signal model includes a third preset threshold and a fourth preset threshold, the output signal model stores a correspondence, corresponding to the third preset threshold, between a comparison result and a fault identification result, and the output signal model further stores a correspondence, corresponding to the fourth preset threshold, between a comparison result and a fault identification result. The sensor has a feature output current signal or output voltage signal. For example, an output current signal of a pressure sensor may be converted into a required pressure signal or temperature signal through specific conversion. An internal output current of the pressure sensor is 4 to 20 mA. When the output current is less than a preset current (for example, 1.185 mA), the pressure sensor is disconnected, and a line needs to be checked. When the output current is greater than a preset current (for example, 22.81 mA), the pressure sensor is faulty, and the sensor needs to be checked and replaced. It should be noted that the preset threshold and the correspondence between the comparison result and the fault identification result, which are stored in the preset mechanism model corresponding to the output signal, may be set according to an actual requirement, and are not specifically limited in this embodiment. When an actual output signal is determined by using the preset threshold stored in the preset mechanism model corresponding to the output signal, to implement fault identification of the target sensor, an obtained fault identification result not only includes whether the target sensor has a fault and a fault type (namely, a disconnection fault) corresponding to the target sensor when the target sensor has a fault.

An actual spectrum of the target sensor is actually an FFT spectrum. The FFI spectrum may provide a quick indication of signal quality. The spectrum model may alternatively store a plurality of preset thresholds. For the spectrum model, the spectrum model further stores a correspondence, corresponding to each preset threshold, between a comparison result and a fault identification result. For example, a fifth preset threshold corresponding to frequency and a sixth preset threshold corresponding to time may be stored in the spectrum model. The fifth preset threshold may be zero. A correspondence, corresponding to the fifth preset threshold, between a comparison result and a fault identification result may be stored in the spectrum model. When time and frequency in a spectrum are both zero, it represents that the sensor is disconnected. Referring to FIG. 26, a lowest frequency line in an FFT spectrum has an unexpectedly high (usually, highest) amplitude. The amplitude usually decreases as frequency increases, thereby presenting a ski slope contour. The presence of a large ski slope contour indicates deformation caused by sensor overload. Therefore, a corresponding preset threshold may be set according to the foregoing characteristic, to identify whether a fault type corresponding to the sensor is deformation caused by overload when the sensor is faulty. Specifically, preset thresholds (for example, a sixth preset threshold, a seventh preset threshold, and an eighth preset threshold) corresponding to a plurality of ski slope factors and correspondences, corresponding to different preset thresholds, between a comparison result and a fault identification result may be stored in the spectrum model. The different preset thresholds represent deformation of different levels caused by overload. Based on the obtained actual spectrum, ski slope factors may be determined, to determine a final fault identification result according to the ski slope factors, and the preset thresholds corresponding to the plurality of ski slope factors and the correspondences, corresponding to different preset thresholds, between a comparison result and a fault identification result stored in the spectrum model.

In the foregoing, the determining the ski slope factor according to the actual spectrum includes:
obtaining a plurality of preset frequency intervals corresponding to the target sensor;
determining, for each of the preset frequency intervals, a pass frequency within the preset frequency interval according to the actual spectrum; and
determining the ski slope factor according to all the pass frequencies.

In this embodiment, different sensor types cause the sensors to have different characteristics, and further cause preset frequency intervals to be different. Therefore, a plurality of preset frequency intervals corresponding to the target sensor may be set according to an actual requirement. According to all the pass frequencies, the ski slope factor may be determined by using the following formula:

$$ski\_factor = \frac{sp1\_rms}{\sqrt{sp1\_rms * 2 + sp2\_rms * 2 + …… + spi\_rms * 2}}$$

In the foregoing formula, ski_factor represents the ski slope factor, sp1_rms represents the smallest preset frequency interval, sp2_rms represents the second smallest preset frequency interval, spi_rms represents the largest preset frequency interval, and i represents the number of the preset frequency intervals.

According to the sensor fault identification method provided in this embodiment, based on determining a fault identification model corresponding to a target sensor and obtaining a preset mechanism model that is disposed in advance and corresponds to the target sensor, fault identification is performed on the target sensor with reference to the fault identification model and the preset mechanism model in a working process of the target sensor, to obtain final target fault identification result(s), thereby implementing fault identification of the target sensor, avoiding disadvantages of periodically performing fault identification on the target sensor manually, reducing expenditure of manpower and material power, and improving production efficiency of a mechanical device provided with the target sensor.

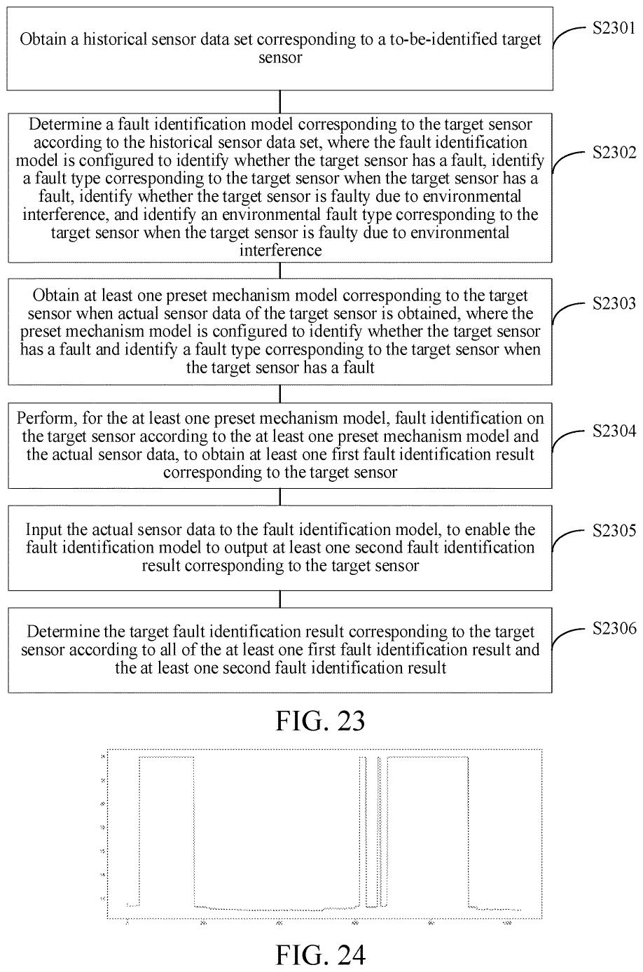

Refer to FIG. 23. FIG. 23 is still another sensor fault identification method according to an embodiment of the present disclosure. The sensor fault identification method provided in this embodiment includes the following methods.
S2301: Obtain a historical sensor data set corresponding to a to-be-identified target sensor.

In this embodiment, Step S2301 is the same as step S2101. For details, refer to the foregoing step S2101. Details are not described herein again in this embodiment.
S2302: Determine a fault identification model corresponding to the target sensor according to the historical sensor data set, where the fault identification model is configured to identify whether the target sensor has a fault, identify a fault type corresponding to the target sensor when the target sensor has a fault, identify whether the target sensor is faulty due to environmental interference, and identify an environmental fault type corresponding to the target sensor when the target sensor is faulty due to environmental interference.

In this embodiment, the fault identification model not only may be used to identify whether the target sensor is faulty due to environmental interference and identify an environmental fault type corresponding to the target sensor when the target sensor is faulty due to environmental interference, but also may be used to identify a fault of the target sensor and a fault type corresponding to the target sensor when the target sensor has a fault, so as to perform fault identification of the target sensor. If it is identified, by using the at least one preset mechanism model disposed in advance, that the target sensor has a fault, whether the target sensor has a fault may be identified according to the fault identification model, to determine a final fault identification result with reference to identification results of the fault identification model and the preset mechanism model, thereby improving accuracy of sensor fault identification. In addition, when the preset mechanism model does not identify that the target sensor has a fault, the fault identification model may further be used to identify a fault of the target sensor caused by environmental interference, to implement fault identification of the target sensor.
S2303: Obtain at least one preset mechanism model corresponding to the target sensor when actual sensor data of the target sensor is obtained, where the preset mechanism model is configured to identify whether the target sensor has a fault and identify a fault type corresponding to the target sensor when the target sensor has a fault.
S2304: Perform, for each preset mechanism model of the at least one preset mechanism model, fault identification on the target sensor according to the preset mechanism model and the actual sensor data, to obtain first fault identification result(s) corresponding to the target sensor.

For the foregoing step S2303 and step S2304, step S2303 is the same as step S2203, and step S2304 is the same as step S2204. For details, refer to step S2203 and step S2204. Details are not described herein again in this embodiment.
S2305: Input the actual sensor data to the fault identification model, to enable the fault identification model to output second fault identification result(s) corresponding to the target sensor.

In this embodiment, in the process of performing step S2304, step S2305 is synchronously performed, to identify whether the target sensor has a fault, identify a fault type corresponding to the target sensor when the target sensor has a fault, identify whether the target sensor is faulty due to environmental interference, and identify an environmental fault type corresponding to the target sensor when the target sensor is faulty due to environmental interference.
S2306: Determine the target fault identification result(s) corresponding to the target sensor according to all the first fault identification result(s) and the second fault identification result(s).

In this embodiment, after all the first fault identification result(s) and the second fault identification result(s) are obtained, final target fault identification result(s) corresponding to the target sensor may be obtained by combining all the first fault identification result(s) and the second fault identification result(s).

Specifically, the determining the target fault identification result(s) corresponding to the target sensor according to all the first fault identification result(s) and the second fault identification result(s) includes:
determining whether fault identification result(s) consistent with all the first fault identification result(s) exist in the second fault identification result(s);
determining, when fault identification result(s) consistent with all the first fault identification result(s) exist in the second fault identification result(s), the second fault identification result(s) as the target fault identification result(s) corresponding to the target sensor;
generating, when a fault identification result inconsistent with at least one of the first fault identification results exist(s) in the second fault identification result(s), alarm prompt information according to the at least one inconsistent first fault identification result; and
pushing the alarm prompt information to a target terminal corresponding to the target sensor.

In this embodiment, the target terminal may be a mobile phone, a tablet, or the like. A specific form of the target terminal may be selected according to an actual requirement. The form of the target terminal is not specifically limited in this embodiment. When fault identification result(s) consistent with all the first fault identification result(s) exist in the second fault identification result(s), it represents that the identification result of the fault identification model is consistent with that of the preset mechanism model. The fault identification model can further identify a fault caused by environmental interference. Therefore, to improve accuracy of sensor fault identification, the second fault identification result(s) is determined as the target fault identification result(s). When a fault identification result inconsistent with the at least one of the first fault identification result(s) exists in the second fault identification result(s), it may be that setting of a preset threshold stored in a preset mechanism model is inaccurate or setting of a training parameter in the fault identification model is inaccurate. To further improve accuracy of sensor fault identification, alarm prompt information may be generated according to the at least one inconsistent first fault identification result, and the alarm prompt information is pushed to the target terminal corresponding to the target sensor, to update the preset mechanism model or the fault identification model. A specific form of the alarm prompt information may be set according to an actual requirement. The specific form of the alarm prompt information is not limited in this embodiment.

According to the sensor fault identification method provided in this embodiment, based on determining a fault identification model corresponding to a target sensor and obtaining a preset mechanism model that is disposed in advance and corresponds to the target sensor, fault identification is performed on the target sensor with reference to the fault identification model and the preset mechanism model in a working process of the target sensor, to obtain final target fault identification result(s), thereby implementing fault identification of the target sensor, avoiding disadvantages of periodically performing fault identification on the target sensor manually, reducing expenditure of manpower and material power, and improving production efficiency of a mechanical device provided with the target sensor.

Refer to FIG. 27. FIG. 27 is a schematic structural diagram of a sensor fault identification apparatus according to an embodiment of the present disclosure. A sensor fault identification apparatus provided in an embodiment of the present disclosure includes: an obtaining module 10, a determining module 20, and an identification model 30. The obtaining module 10 is configured to obtain a historical sensor data set corresponding to a to-be-identified target sensor. The determining module 20 is configured to determine, according to the historical sensor data set, a fault identification model corresponding to the target sensor. The obtaining module 10 is further configured to obtain at least one preset mechanism model corresponding to the target sensor when actual sensor data of the target sensor is obtained, where the preset mechanism model is configured to identify whether the target sensor has a fault and identify a fault type corresponding to the target sensor when the target sensor has a fault. The identification module 30 is configured to perform fault identification on the target sensor according to the fault identification model, the at least one preset mechanism model, and the actual sensor data, to obtain target fault identification result(s) corresponding to the target sensor.

In this embodiment, the fault identification model is configured to identify whether the target sensor is faulty due to environmental interference and identify an environmental fault type corresponding to the target sensor when the target sensor is faulty due to environmental interference.

In this embodiment, the identification module 30 is further configured to:
perform, for each preset mechanism model of the at least one preset mechanism model, fault identification on the target sensor according to the preset mechanism model and the actual sensor data, to obtain first fault identification result(s) corresponding to the target sensor; and
input the actual sensor data to the fault identification model when all the first fault identification results are that the target sensor does not have a fault, to enable the fault identification model to output the target fault identification result(s) corresponding to the target sensor.

In this embodiment, the fault identification model is configured to identify whether the target sensor has a fault, identify a fault type corresponding to the target sensor when the target sensor has a fault, identify whether the target sensor is faulty due to environmental interference, and identify an environmental fault type corresponding to the target sensor when the target sensor is faulty due to environmental interference.

In this embodiment, the identification module 30 is further configured to:
perform, for each preset mechanism model of the at least one preset mechanism model, fault identification on the target sensor according to the preset mechanism model and the actual sensor data, to obtain first fault identification result(s) corresponding to the target sensor;
input the actual sensor data to the fault identification model, to enable the fault identification model to output second fault identification result(s) corresponding to the target sensor; and
determine the target fault identification result(s) corresponding to the target sensor according to all the first fault identification result(s) and the second fault identification result(s).

In this embodiment, the identification module 30 is further configured to:
determine whether fault identification result(s) consistent with all the first fault identification result(s) exist in the second fault identification result(s);
determine, when fault identification result(s) consistent with all the first fault identification result(s) exist in the second fault identification result(s), the second fault identification result(s) as the target fault identification result(s) corresponding to the target sensor;
generate, when a fault identification result inconsistent with at least one of the first fault identification result(s) exists in the second fault identification result(s), alarm prompt information according to the at least one inconsistent first fault identification result; and
push the alarm prompt information to a target terminal corresponding to the target sensor.

In this embodiment, the determining module 20 is further configured to:
perform, for each piece of historical sensor data in the historical sensor data set, fault classification labeling on the historical sensor data, to obtain training sample data corresponding to the historical sensor data; and
train a preset classification model according to the training sample data corresponding to all the historical sensor data in the historical sensor data set, to obtain the fault identification model corresponding to the target sensor.

In this embodiment, the at least one preset mechanism model includes a bias voltage model, an output signal model, and a spectrum model. The actual sensor data includes an actual bias voltage, an actual output signal value, and an actual spectrum. Each preset mechanism model stores a preset threshold and a correspondence between a comparison result and a fault identification result. The comparison result is a result of comparison between the actual sensor data and the preset threshold.

In this embodiment, the identification module 30 is further configured to:
compare, when the preset mechanism model is the bias voltage model, the actual bias voltage with the preset threshold in the bias voltage model, to obtain a first comparison result; and determine first fault identification result(s) corresponding to the first comparison result according to the correspondence between the comparison result and a fault identification result in the bias voltage model;
compare, when the preset mechanism model is the output signal model, the actual output signal value with the preset threshold in the output signal model, to obtain a second comparison result; and determine first fault identification result(s) corresponding to the second comparison result according to the correspondence between the comparison result and a fault identification result in the output signal model; and
determine, when the preset mechanism model is the spectrum model, a ski slope factor according to the actual spectrum; compare the ski slope factor with the preset threshold in the spectrum model, to obtain a third comparison result; and determine first fault identification result(s) corresponding to the third comparison result according to the correspondence between the comparison result and a fault identification result in the spectrum model.

In this embodiment, the identification model 30 is further configured to:
obtain a plurality of preset frequency intervals corresponding to the target sensor;
determine, for each of the preset frequency intervals, a pass frequency within the preset frequency interval according to the actual spectrum; and
determine the ski slope factor according to all the pass frequencies.

According to the sensor fault identification apparatus provided in this embodiment, based on determining a fault identification model corresponding to a target sensor and obtaining a preset mechanism model that is disposed in advance and corresponds to the target sensor, fault identification is performed on the target sensor with reference to the fault identification model and the preset mechanism model in a working process of the target sensor, to obtain final target fault identification result(s), thereby implementing fault identification of the target sensor, avoiding disadvantages of periodically performing fault identification on the target sensor manually, reducing expenditure of manpower and material power, and improving production efficiency of a mechanical device provided with the target sensor.

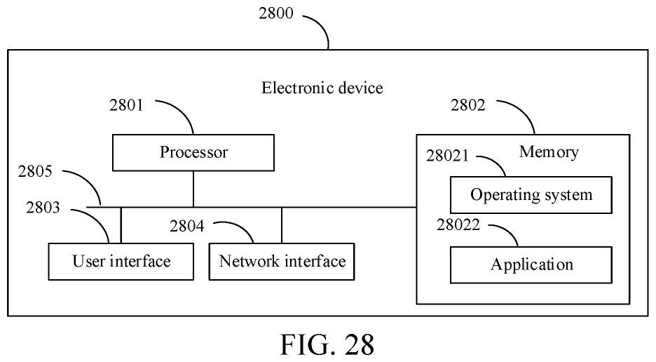

FIG. 28 is a schematic structural diagram of an electronic device according to an embodiment of the present disclosure. An electronic device 2800 shown in FIG. 28 includes: at least one processor 2801, a memory 2802, at least one network interface 2804, and another user interface 2803. Components in the electronic device 2800 are coupled together by using a bus system 2805. It may be understood that the bus system 2805 is configured to implement connection and communication between the components. In addition to a data bus, the bus system 2805 further includes a power bus, a control bus, and a status signal bus. However, for ease of clear description, all types of buses are labeled as the bus system 2805 in FIG. 28.

The user interface 2803 may include a display, a keyboard or a clicking device (such as a mouse or a trackball), a touch panel, or a touch screen.

It may be understood that the memory 2802 in this embodiment of the present disclosure may be a volatile memory or a non-volatile memory, or may include both a volatile memory and a non-volatile memory. The non-volatile memory may be a ROM, a programmable ROM (PROM), an erasable PROM (EPROM), an electrically EPROM (EEPROM), or a flash RAM. The volatile memory may be a RAM, and is used as an external cache. By way of example but not limited description, RAMs in many forms are available, for example, a static RAM (SRAM), a dynamic RAM (DRAM), a synchronous DRAM (SDRAM), a double data rate SDRAM (DDRSDRAM), an enhanced SDRAM (ESDRAM), a synch link DRAM (SLDRAM), and a direct Rambus RAM (DRRAM). The memory 2802 described in this specification is intended to include but is not limited to these memories and any other suitable type of memory.

In some implementations, the memory 2802 stores the following elements, executable units, or data structures, or a subset thereof, or an extension set thereof: an operating system 28021 and an application 28022.

The operating system 28021 includes various system programs, for example, a frame layer, a core library layer, and a driver layer, and is configured to implement various basic services and process hardware-based tasks. The application 28022 includes various applications, for example, a media player and a browser, for implementing various application services. Programs for implementing the methods according to the embodiments of the present disclosure may be included in the application 28022.

In this embodiment of the present disclosure, the programs or instructions stored in the memory 2802 are invoked. Specifically, the programs or instructions stored in the application 28022 may be invoked. The processor 2801 is configured to perform method steps provided in the method embodiments, for example, including: obtaining a historical sensor data set corresponding to a to-be-identified target sensor; determining, according to the historical sensor data set, a fault identification model corresponding to the target sensor; obtaining at least one preset mechanism model corresponding to the target sensor when actual sensor data of the target sensor is obtained, where the preset mechanism model is configured to identify whether the target sensor has a fault and identify a fault type corresponding to the target sensor when the target sensor has a fault; and performing fault identification on the target sensor according to the fault identification model, the at least one preset mechanism model, and the actual sensor data, to obtain target fault identification result(s) corresponding to the target sensor.

The method disclosed in the foregoing embodiment of the present disclosure may be applied to the processor 2801, or may be implemented by the processor 2801. The processor 2801 may be an integrated circuit chip having a signal processing capability. In an implementation process, the steps of the foregoing method may be completed by using a hardware integrated logic circuit in the processor 2801 or an instruction in a form of software. The foregoing processor 2801 may be a general-purpose processor, a digital signal processor (DSP), an application specific integrated circuit (ASIC), a field programmable gate array (FPGA), or another programmable logic device, discrete gate or transistor logic device, or discrete hardware component. The methods, steps, and logic block diagrams disclosed in the embodiments of the present disclosure may be implemented or executed. The general-purpose processor may be a microprocessor, or the processor may be any conventional processor or the like. The steps of the method disclosed in connection with the embodiments of the present disclosure may be directly embodied as execution by a hardware decoding processor, or may be executed by a combination of hardware and software units in the decoding processor. The software unit may be located in a storage medium well-established in the art, such as a RAM, a flash RAM, a ROM, a PROM, or an EEPROM, or a register. The storage medium is located in the memory 2802. The processor 2801 reads information in the memory 2802, and completes the steps of the foregoing method in combination with hardware thereof.

It may be understood that the embodiments described in this specification may be implemented by using hardware, software, firmware, middleware, microcode, or a combination thereof. For a hardware implementation, a processing unit may be implemented in one or ASICS, DSPs, DSP devices (DSPDs), programmable logic devices (PLDs), FPGAs, general-purpose processors, controllers, microcontrollers, microprocessors, other electronic units configured to perform functions described in the present disclosure, or a combination thereof.

For a software implementation, the technology described in this specification may be implemented by using a unit that performs the function described in this specification. Software code may be stored in the memory and executed by the processor. The memory may be implemented in the processor or external to the processor.

The electronic device provided in this embodiment may be an electronic device shown in FIG. 28, and may perform all the steps of the fault prediction method in FIG. 1, all the steps of the fault monitoring method in FIG. 6, all the steps of the fault monitoring method for dynamic equipment in FIG. 13 to FIG. 15, and FIG. 18, or all the steps of the sensor fault identification method in FIG. 21 to FIG. 23, so as to achieve technical effects of the methods shown in the foregoing figures. For details, reference is made to related descriptions in the foregoing figures. For concise descriptions, details are not described herein again.

An embodiment of the present disclosure further provides a storage medium (computer-readable storage medium). The storage medium herein stores one or more programs. The storage medium may include a volatile memory such as a RAM. The memory may alternatively include a non-volatile memory such as a ROM, a flash RAM, a hard disk, or a solid-state drive. The memory may further include a combination of the foregoing types of memories.

One or more programs in the storage medium may be executed by one or more processors, to implement the foregoing fault prediction method, fault monitoring method, fault monitoring method for dynamic equipment, or sensor fault identification method performed by a sensor fault identification device.

The processor is configured to execute a sensor fault identification program stored in the memory, to implement the following steps of the sensor fault identification method performed by the sensor fault identification device: obtaining a historical sensor data set corresponding to a to-be-identified target sensor; determining, according to the historical sensor data set, a fault identification model corresponding to the target sensor; obtaining at least one preset mechanism model corresponding to the target sensor when actual sensor data of the target sensor is obtained, where the preset mechanism model is configured to identify whether the target sensor has a fault and identify a fault type corresponding to the target sensor when the target sensor has a fault; and performing fault identification on the target sensor according to the fault identification model, the at least one preset mechanism model, and the actual sensor data, to obtain target fault identification result(s) corresponding to the target sensor.

Those skilled in the art will further appreciate that the elements and algorithmic steps of the examples described in connection with the embodiments disclosed in this specification can be implemented in electronic hardware, computer software, or a combination of both. The components and steps of the examples have been described generally in terms of functionality in the foregoing description in order to clearly illustrate the interchangeability of hardware and software. Whether the functions are executed in a manner of hardware or software depends on particular applications and design constraints of the technical solutions. Those skilled in the art may use different methods to implement the described functions for each particular application, but it should not be considered that the implementation goes beyond the scope of the present disclosure.

It should be noted that “an implementation”, “an embodiment”, “an example embodiment”, “some embodiments”, and the like mentioned in the specification indicate that the described embodiments may include a particular feature, structure, or characteristic, but each embodiment does not necessarily include the particular feature, structure, or characteristic. In addition, such phrases do not necessarily refer to a same embodiment. In addition, when the particular feature, structure, or characteristic is described with reference to an embodiment, it is within the knowledge scope of those skilled in the art to implement the feature, structure, or characteristic with reference to another embodiment that is clearly described or not clearly described.

It should be noted that relational terms such as “first” and “second” are used merely to distinguish one entity or operation from another entity or operation, and do not necessarily require or imply any such actual relationship or order between the entities or operations in this specification. Moreover, the terms “include,” “comprise,” and any variation thereof are intended to cover a non-exclusive inclusion. Therefore, in the context of a process, a method, an object, or a device that includes a series of elements, the process, method, object, or device not only includes such elements, but also includes other elements not specified expressly, or may include inherent elements of the process, method, object, or device. Without more limitations, an element defined by a sentence “including a” does not exclude a case that there are still other same elements in the process, method, article, or device that includes the element.

Finally, it should be noted that the foregoing embodiments are merely used for describing the technical solutions of the present disclosure, but are not intended to limit the technical solutions. Although the present disclosure is described in detail with reference to the foregoing embodiments, it should be appreciated by those of ordinary skill in the art that modifications may still be made to the technical solutions described in the foregoing embodiments, or equivalent replacements may be made to part or all of the technical features. However, these modifications or replacements do not cause the essence of the corresponding technical solutions to deviate from the scope of the technical solutions in the embodiments of the present disclosure.

1.-38. (canceled)

39. A fault monitoring method for dynamic equipment, applied to a fault monitoring system for the dynamic equipment, the method comprising:
determining a plurality of test points of the dynamic equipment and a parameter retrieval rule of each of the test points;
retrieving, for each of the test points, target parameter data of the test point according to the corresponding parameter retrieval rule;
determining a fault symptom quantification of the test point according to the target parameter data;
determining an operating status of each of the test points based on the fault symptom quantification corresponding to each of the test points; and
determining a fault point and a fault type of the dynamic equipment according to the operating status of each of the test points when determining, according to the operating status of each of the test points, that the dynamic equipment has a fault.

40. The method according to claim 39, wherein:
retrieving, for each of the test points, the target parameter data of the test point according to the corresponding parameter retrieval rule comprises:
obtaining, for each of the test points, the target parameter data corresponding to the test point from a database according to the parameter retrieval rule corresponding to the test point, wherein the database stores the following types of parameter data of the dynamic equipment: static attribute data of the dynamic equipment, maintenance record data of the dynamic equipment, operating data of the dynamic equipment, and sensor signal data of the dynamic equipment acquired by using a sensor; and
the method further comprises:
obtaining a preset sensor acquisition rule; and
controlling, according to the preset sensor acquisition rule, a corresponding sensor to acquire corresponding sensor signal data.

41. The method according to claim 39, wherein:
determining the parameter retrieval rule of each of the test points comprises:
obtaining position information of each of the test points on the dynamic equipment; and
determining the parameter retrieval rule of each of the test points according to the position information; and
determining the fault symptom quantification of the test point according to the target parameter data comprises:
determining, according to the position information of the test point, a feature value calculation rule and a fault symptom quantification calculation rule corresponding to the test point;
performing calculation based on the target parameter data according to the feature value calculation rule, to obtain at least one feature value corresponding to the test point; and
performing data combination on the target parameter data and/or the feature value according to the fault symptom quantification calculation rule, to generate the fault symptom quantification of the test point.

42. The method according to claim 39, wherein determining the operating status of each of the test points based on the fault symptom quantification corresponding to each of the test points comprises:
obtaining a maximum rotational speed and a minimum rotational speed of the dynamic equipment within a plurality of operating periods;
determining a rotational speed difference between the maximum rotational speed and the minimum rotational speed, and determining whether the rotational speed difference is less than a preset difference threshold; and
determining, when the rotational speed difference is less than the difference threshold, the operating status of each of the test points based on a preset dynamic early-warning model and the fault symptom quantification corresponding to each of the test points.

43. The method according to claim 42, wherein determining the operating status of each of the test points based on the preset dynamic early-warning model and the fault symptom quantification corresponding to each of the test points further comprises:
obtaining historical operating data of the dynamic equipment within a preset historical time period and a configuration parameter of the preset dynamic early-warning model;
inputting the historical operating data, the fault symptom quantification corresponding to each of the test points, and the configuration parameter to the dynamic early-warning model, to obtain an early-warning result of the dynamic early-warning model corresponding to each fault symptom quantification; and
determining the operating status of each of the test points based on the early-warning result corresponding to each fault symptom quantification, wherein the operating status comprises a faulty state and a non-faulty state.

44. The method according to claim 43, wherein the fault symptom quantification comprises a sensor abnormality symptom quantification, and determining the operating status of each of the test points based on the early-warning result corresponding to each fault symptom quantification comprises:
determining whether an early-warning result corresponding to the sensor abnormality symptom quantification is fault early-warning;
outputting, if it is determined that the early-warning result corresponding to the sensor abnormality symptom quantification is fault early-warning, alarm information about an abnormality of the sensor, and otherwise, if the early-warning result corresponding to the sensor abnormality symptom quantification is non-fault early-warning:
obtaining sensor signal data acquired by a sensor;
inputting the sensor signal data to a preset sensor fault identification model, to obtain a sensor abnormality identification result output by the sensor fault identification model;
determining, if the sensor abnormality identification result represents that an anomaly occurs in the sensor, that the operating status of each of the test points is the non-faulty state; and
determining, if the sensor abnormality identification result represents that no anomaly occurs in the sensor, an early-warning result level of each fault symptom quantification corresponding to each of the test points, and determining a fault status corresponding to an early-warning result having a highest early-warning result level as the operating status of the test point.

45. The method according to claim 44, wherein:
determining, according to the operating status of each of the test points, that the dynamic equipment has a fault comprises:
determining, when the operating status of any of the test points is in the faulty state, that the dynamic equipment has a fault; and
determining the fault point and the fault type of the dynamic equipment according to the operating status of each of the test points comprises:
determining whether the operating status of each of the test points is the faulty state;
determining a test point of which the operating status is the faulty state as an initial fault point; and
inputting, for each initial fault point, an early-warning result corresponding to the initial fault point to a preset fault detection model, to obtain the fault point and the fault type of the dynamic equipment that are output by the fault detection model.

46. The method according to claim 45, wherein:
the fault detection model comprises a typical fault classification model and a fault analysis model, the typical fault classification model is configured to determine whether the fault type of the dynamic equipment is a typical fault type, the fault analysis model is configured to analyze a fault point and a basic fault type of the dynamic equipment, and
inputting the early-warning result corresponding to the initial fault point to the preset fault detection model, to obtain the fault point and the fault type of the dynamic equipment that are output by the fault detection model comprises:
inputting the early-warning result corresponding to the initial fault point to the typical fault classification model and the fault analysis model respectively, to obtain a typical fault classification result output by the typical fault classification model and a fault analysis result output by the fault analysis model; and
performing weighted summation on the typical fault classification result and the fault analysis result, to obtain the fault point and the fault type corresponding to the dynamic equipment.

47. The method according to claim 46, further comprising:
determining whether the fault type is the typical fault type;
retrieving, when the fault type is the typical fault type, the fault type against a preset typical fault case library, to obtain a target solution corresponding to the fault type, wherein the typical fault case library is configured for storing typical faults and a solution corresponding to each of the typical faults; and
outputting the target solution by using a visual interface.

48. The method according to claim 40, further comprising:
performing, according to a preset signal processing rule, signal processing and feature transformation on the parameter data of the dynamic equipment stored in the database, to obtain a plurality of types of graph data; and
outputting the graph data by using a visual interface, to analyze the dynamic equipment according to the graph data.

49. The method according to claim 39, wherein after determining the fault point and the fault type of the dynamic equipment, the method further comprises:
generating a three-dimensional image of the dynamic equipment;
labeling the fault point and the fault type of the dynamic equipment in the three-dimensional image, to obtain a target three-dimensional image; and
outputting the target three-dimensional image, and performing early-warning in a preset early-warning manner.

50. A fault monitoring apparatus for dynamic equipment, comprising a memory for storing instructions and at least one processor for executing the instructions to:
determine a plurality of test points of the dynamic equipment and a parameter retrieval rule of each of the test points;
retrieve, for each of the test points, target parameter data of the test point according to the corresponding parameter retrieval rule;
determine a fault symptom quantification of the test point according to the target parameter data;
determine an operating status of each of the test points based on the fault symptom quantification corresponding to each of the test points; and
determine a fault point and a fault type of the dynamic equipment according to the operating status of each of the test points when determining, according to the operating status of each of the test points, that the dynamic equipment has a fault.

51. An electronic device, comprising: a processor and a memory, the processor being connected to the memory, and the processor being configured to execute a fault prediction program, a fault monitoring program, a fault monitoring program for dynamic equipment, or a sensor fault identification program stored in the memory, to implement the fault monitoring method for dynamic equipment according to claim 39.

52. A non-transitory computer-readable storage medium for storing one or more programs, the one or more programs being executable by one or more processors, to implement the fault monitoring method for dynamic equipment according to claim 39.
